(19) United States
(12) Patent Application Publication
(10) Pub. No.: US 2008/0259361 A1
(43) Pub. Date: Oct. 23, 2008

(54) High quality halftone process

(76) Inventor: Toshiaki Kakutani, Shiojiri-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/906,953

(22) Filed: Oct. 3, 2007

(30) Foreign Application Priority Data
Oct. 3, 2006 (JP) 2006-272215

(51) Int. Cl. G06K 15/10; G06K 1/00

(52) U.S. Cl. 358/1.8; 358/3.06; 358/3.13

(57) ABSTRACT

The invention provides a printing method of printing on a printing medium. The method includes: generating dot data that represents state of dot formation at each print pixel of a print image to be formed on the printing medium by performing a halftone process on image data that represents an input tone value of each pixel making up an original image; providing a print head capable of selectively forming N types of dots having mutually different sizes on a region of one pixel on the printing medium, N being an integer of at least 2; and generating the print image according to the dot data by mutually combining a plurality of dot groups in a common print region, each of the plurality of dot groups being formed on each of a plurality of pixel groups that assume mutually physical differences in a process of dot formation. The generating dot data includes: executing the halftone process by using an error diffusion method with respect to smaller-size-side dot among the N types of dots; and executing the halftone process by using a dither method with respect to larger-size-side dot among the N types of dots, a condition of halftone process of the dither method being set such that all of the dot groups have a first predetermined characteristic.

### BACKGROUND

1. Technical Field

The present invention relates to technology for printing images by forming dots on a printing medium.

2. Related Art

As output devices of images created by computers or images taken by digital cameras, print apparatuses that print images by forming dots on printing media are widely used. Halftone processes are employed for representation of tones in such print apparatuses, since the number of tones available to dots that can be formed in response to input tone values is small. As for halftone processes, methods such as an ordered dither method (simply referred to as a dither method in the present specification) using a dither matrix and an error diffusion method are widely used. Conventionally, the dither method and the error diffusion method were technically characterized as having small processing load but providing lower image quality and having large processing load but providing higher image quality, respectively.

Meanwhile, the applicable scope of error diffusion, which has large processing load but can obtain high image quality, has been expanding along with enhancement of processing capabilities of computers. On the other hand, JP-A-2000-125121 and Japanese Patent No. 3001002 also disclose techniques that, for example, combine the dither method with the error diffusion method for the purpose of preventing degradation of image quality that occurs in some tone ranges, which is a problem in error diffusion that employs a plurality of threshold values to execute multi-valuing process.

However, since the dither method has undergone an unique progress and has remarkably improved image quality by virtue of the invention by the inventors of the present application, the technical characterizations of the dither method and the error diffusion method have become different from conventional. However, some problems still remain unsolved, such as how the dither method and the error diffusion method that have different technical characterizations should be combined to achieve a halftone process, or whether or not either one of the methods should be used singularly.

### SUMMARY

An advantage of some aspect of the invention is to provide a technique for improving image quality with a halftone process using a preferred combination of dither method and error diffusion method.

According to an aspect of the invention, there is provided a printing method of printing on a printing medium. The method includes: generating dot data that represents state of dot formation at each print pixel of a print image to be formed on the printing medium by performing a halftone process on image data that represents an input tone value of each pixel making up an original image; providing a print head capable of selectively ejecting N types of ink droplets having mutually different ink amounts on the printing medium to form the N types of dots having mutually different sizes on a region of one pixel, N being an integer of at least 2; and generating the print image according to the dot data by mutually combining a plurality of dot groups in a common print region, each of the plurality of dot groups being formed on each of a plurality of pixel groups that assume mutually physical differences in a process of dot formation. The generating dot data includes: executing the halftone process by using an error diffusion method with respect to smaller-size-side dot among the N types of dots; and executing the halftone process by using a dither method with respect to larger-size-side dot among the N types of dots, a condition of halftone process of the dither method being set such that all of the dot groups have a first predetermined characteristic.

In a print apparatus of the present invention, a halftone technique is switched according to dot sizes, between a specific dither method (a dither method in which condition of a halftone process is set such that every one of dot groups, which are assumed to have physical difference in process of dot formation and are formed on respective pixel groups, has a first predetermined characteristic) and an error diffusion method. Such switching is aimed at taking advantage of characteristics of both of these methods. The feature of the specific dither method is that in case where a print image is generated by mutually combining dot groups having physical difference in process of dot formation (e.g. difference of main scanning direction along which dots are formed) in a common print region, degradation of image quality attributable to such combination can be reduced. The specific dither method, however, also has a feature that a remarkable effect can be produced if dot density of each dot group is large such that interaction between the dot groups affects image quality, but no remarkable effect can be obtained if each dot group has small dot density. On the other hand, the feature of the error diffusion method is that dots making up a print image can be dispersed better than in the case of the specific dither method, if not considering the problem of interaction between the dot groups.

It is the inventors of the present application who analyzed for the first time the features of both of these methods through experiments and analysis, by employing the specific dither method created by the inventors of the present application and the error diffusion method, with a focus on physical difference in process of dot formation (e.g. difference of main scanning direction along which dots are formed). The invention of the present application was created based on such a new point of view.

Note that “physical difference” not only include any misalignment of dot due to error in mechanism of a print apparatus such as measuring error of print head position, measuring error of sub scan feed amount, and the like, but also has a broader meaning including factors such as misalignment of dot in the main scanning direction due to uplift of print paper, deviation (time lag) or sequence of ink ejection timing (temporal error), and the like. The positional misalignment of dot becomes obvious as, for example, positional misalignment between dots formed by forward pass of main scan by a print head and dots formed by backward pass of main scan by the print head in the main scanning direction. The “dot density” represents a product of a dot recording rate and a dot area. Accordingly, together with the fact that a dot recording rate of small-size dot has an upper limit (suppression of banding), any region that is represented by small-size dot always results in representing a region of small dot density.

Note that, in techniques disclosed in JP-A-2005-236768 and JP-A-2005-269527 that employ intermediate data (number data) for specifying state of dot formation, the dither method of the present invention has a broader concept that also includes a halftone process that employs a conversion table (or a correspondence relationship table) generated using a dither matrix.

The present invention may also be reduced to practice by a diversity of forms such as a dither matrix, a dither matrix generation apparatus, and a printing apparatus, a printing method, and a printed matter generation method employing the dither matrix, or by a diversity of forms such as a computer program used to attain functions of such method or apparatus, and recording medium in which such computer program is recorded.

Furthermore, the use of a dither matrix in a printing apparatus, a printing method, or a printed matter generation method permits whether or not a dot is to be formed on a pixel (hereinafter referred to as dot on/off state) to be determined through comparison on a pixel-by-pixel basis of threshold values established in the dither matrix to the tone values of image data; however, it would also be acceptable to determine the dot on/off state by comparing the sum of threshold value and tone value to a fixed value, for example. It would also be acceptable to determine dot on/off state according to tone values, and data created previously on the basis of threshold values, rather than using threshold values directly. Generally speaking, the dither method of the invention may be any method that permits dot on/off state to be determined according the tone values of pixels, and threshold values established at corresponding pixel locations in a dither matrix.

### BRIEF DESCRIPTION OF THE DRAWINGS

FIG. 1 is a block diagram illustrating the configuration of a printing system in the embodiments.

FIG. 2 is a schematic illustration of a color printer 20.

FIG. 3 is an illustration of a nozzle arrangement on the lower face of print heads 10,20.

FIG. 4 shows the structure of a nozzle Nz and a piezoelectric element PE.

FIG. 5 shows two driving waveforms of the nozzle Nz for ink ejection and a resulting small-size ink droplet IPs ejected in response to the driving waveforms.

FIG. 6 shows two driving waveforms of the nozzle Nz for ink ejection and a resulting medium-size ink droplet IPm ejected in response to the driving waveforms.

FIG. 7 shows a process of using the small-size and medium-size ink droplets IPs and IPm to form three variable-size dots, that is, large-size, medium-size, and small-size dots, at an identical position.

FIG. 8 shows a flowchart showing a routine of a print data generation process executed in the embodiment.

FIG. 9 shows a flowchart showing the details of the halftone process executed in the embodiment of the invention.

FIG. 10 shows a dot recording rate table DT used to determine level data of the three variable-size dots, that is, the large-size, medium-size, and small-size dots.

FIG. 11 shows an example of the principle of determining the dot on-off state according to the dither method.

FIG. 12 shows a flowchart showing the error diffusion method in the embodiment of the invention.

FIG. 13 shows an illustration depicting conceptually part of an exemplary dither matrix.

FIG. 14 shows an illustration depicting the concept of dot on/off state using a dither matrix.

FIG. 15 shows an illustration depicting conceptually exemplary spatial frequency characteristics of threshold values established at pixels in a blue noise dither matrix having blue noise characteristics.

FIG. 16 shows a conceptual illustration of a visual spatial frequency characteristic VTF (Visual Transfer Function) representing acuity of the human visual faculty with respect to spatial frequency.

FIG. 17 shows an illustration of an exemplary print image generating process in the embodiments.

FIG. 18 shows an illustration depicting creation of a print image on a printing medium in the embodiments by means of mutually combining print pixels that belong to multiple pixel groups in a common print region.

FIG. 19 shows a flowchart showing the processing routine of the dither matrix generation method in the embodiment.

FIG. 20 shows an illustration depicting a dither matrix M subjected to a grouping process in the embodiment.

FIG. 21 shows an illustration depicting four divided matrices M1-M4 in the embodiment.

FIG. 22 shows a flowchart showing the processing routine of a dither matrix evaluation process in the embodiment.

FIG. 23 shows an illustration depicting dots formed on each of eight pixels that correspond to elements storing threshold values associated with the first to eighth greatest tendency to dot formation in a dither matrix M.

FIG. 24 shows an illustration depicting a matrix that digitizes a state in which a dot pattern Dpa has been formed.

FIG. 25 shows an illustration depicting four dot patterns formed on print pixels belonging respectively to first to fourth pixel groups, among elements storing the threshold values associated with the first to eighth greatest tendency to dot formation in a dither matrix M.

FIG. 26 shows an illustration depicting dot density matrices that correspond respectively to the four dot patterns.

FIG. 27 shows a flowchart showing the processing routine of an evaluation value determination process in the embodiment of the present invention.

FIG. 28 shows an illustration depicting a computational equation for use in a weighted addition process in the embodiment of the present invention.

FIG. 29 shows a flowchart of an error diffusion method in a modification of the present invention.

FIG. 30 shows a flowchart showing the error diffusion process method in the modification of the present invention.

FIG. 31 shows an illustration depicting an error diffusion same-main scan group matrix Mg1 for the purpose of performing additional error diffusion into the same pixel group as the target pixel.

FIG. 32 shows an error diffusion matrix in another variation example.

### DESCRIPTION OF EXEMPLARY EMBODIMENTS

The preferred embodiments will be described below in the following order, for the purpose of providing a clearer understanding of the operation and working effects of the invention.

### A. Configuration of Printing System in the Embodiments:

B. Print data generation process in the Embodiments:
C. Optimized dither matrix generation method in the Embodiments:

### D. Modification Examples:

### A. Configuration of Printing System in the Embodiments

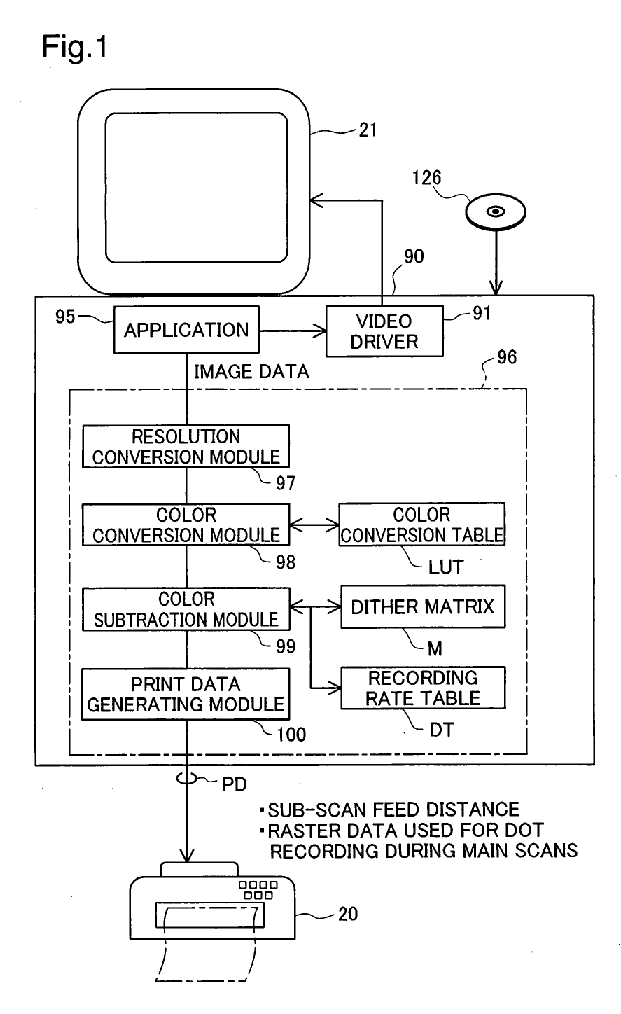

FIG. 1 is a block diagram illustrating the Configuration of a printing system in the embodiments. This printing system is furnished with a computer 90 as a printing control device, and a color printer 20 as a print unit. The color printer 20 and the computer 90 can be termed a “print apparatus” in the broad sense.

On the computer 90, an application program 95 runs on a prescribed operating system. The operating system incorporates a video driver 91 and a printer driver 96; print data PD for transfer to the color printer 20 is output from the application program 95 via these drivers. The application program 95 performs the desired processing of images targeted for processing, as well as outputting images to a CRT 21 via the video driver 91.

Within the printer driver 96 are a resolution conversion module 97 for converting the resolution of an input image to the resolution of the printer; a color conversion module 98 for color conversion from RGB to CMYK; a halftone module 99 that, using an error diffusion method and/or the dither matrices M generated in the embodiments to be discussed later, performs halftone process of input tone values and transform them into output tone values representable by forming dots; a print data generating module 100 that uses the halftone data for the purpose of generating print data to be sent to the color printer 20; a color conversion table LUT serving as a basis for color conversion by the color conversion module 98; and a recording rate table DT for determining recording rates of dots of each size, for the halftone process. The printer driver 96 corresponds to a program for implementing the function of generating the print data PD. The program for implementing the functions of the printer driver 96 is provided in a format recorded on a computer-readable recording medium. Examples of such a recording medium are a CD-ROM 126, flexible disk, magneto-optical disk, IC card, ROM cartridge, punch card, printed matter having a bar code or other symbol imprinted thereon, a computer internal memory device (e.g. RAM, ROM, or other memory) or external memory device, or various other computer-readable media.

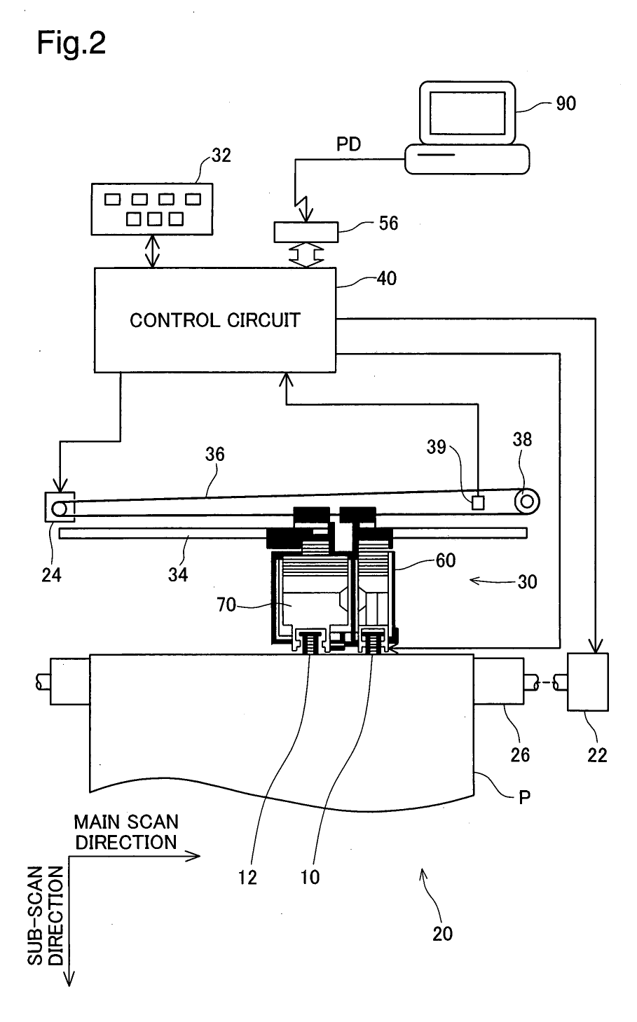

FIG. 2 is a schematic illustration of the color printer 20. The color printer 20 is equipped with a sub scan driving portion for transporting printing paper P in the sub scanning direction by means of a paper feed motor 22; a main scan driving portion for reciprocating a carriage 30 in the axial direction of a paper feed roller 26 (main scanning direction) by means of a carriage motor 24; a head drive mechanism for driving a print head unit 60 installed on the carriage 30 (also termed the “print head assembly”) and controlling ink ejection and dot formation; and a control circuit 40 for exchange of signals with the paper feed motor 22, the carriage motor 24, the print head unit 60 equipped with the print heads 10, 12, and a control panel 32. The control circuit 40 is connected to the computer 90 via a connector 56.

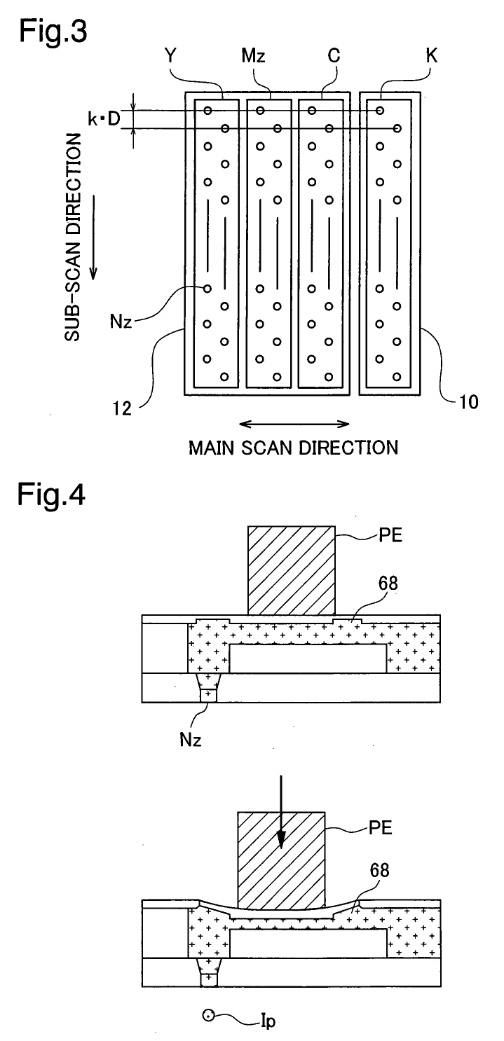

FIG. 3 is an illustration of the nozzle arrangement on the lower face of the print heads 10, 12. On the lower face of the print head 10 there are formed a black ink nozzle group K for ejecting black ink, a cyan ink nozzle group C for ejecting cyan ink, a magenta ink nozzle group Mz for ejecting magenta ink, and a yellow ink nozzle group Y for ejecting yellow ink.

The plurality of nozzles contained in each nozzle group are respectively lined up at a constant nozzle pitch k·D, in the sub scanning direction. Here, k is an integer, and D represents pitch equivalent to the print resolution in the sub scanning direction (also termed “dot pitch”). This will also referred to herein as “the nozzle pitch being k dots.” The “dot” unit means the dot pitch of the print resolution. Similarly, sub scan feed distance is also expressed in “dot” units.

Each nozzle Nz is provided with a piezo element (described later) for the purpose of driving the nozzle Nz and ejecting drops of ink. During printing, ink drops are ejected from the nozzles as the print heads 10, 12 are scanned in the main scanning direction MS.

FIG. 4 shows the structure of a nozzle Nz and a piezoelectric element PE. The piezoelectric element PE is located at a position in contact with an ink passage 68 that leads the flow of ink to the nozzle Nz. In the structure of the embodiment, a voltage is applied between electrodes provided on both ends of the piezoelectric element PE to deform one side wall of the ink passage 68 and thereby attain high-speed ejection of an ink droplet Ip from the end of the nozzle Nz.

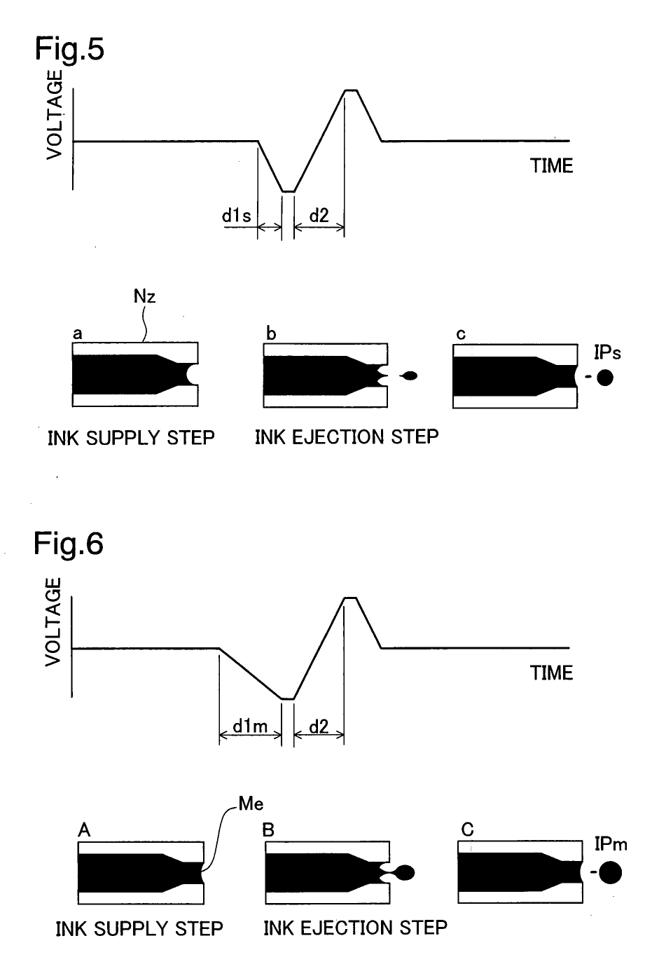

FIGS. 5 and 6 show two driving waveforms of the nozzle Nz for ink ejection and resulting small-size and medium-size ink droplets IPs and IPm ejected in response to the driving waveforms. FIG. 5 shows a driving waveform to eject a small-size ink droplet IPs that independently forms a small-size dot. FIG. 6 shows a driving waveform to eject a medium-size ink droplet IPm that independently forms a medium-size dot.

The small-size ink droplet IPs is ejected from the nozzle Nz by two steps given below, that is, an ink supply step and an ink ejection step:

(1) Ink supply step (d1s): The ink passage 68 (see FIG. 4) is expanded at this step to receive a supply of ink from a non-illustrated ink tank. A decrease in potential applied to the piezoelectric element PE contracts the piezoelectric element PE and thereby expands the ink passage 68; and

(2) Ink ejection step (d2): The ink passage 68 is compressed to eject ink from the nozzle Nz at this step. An increase in potential applied to the piezoelectric element PE expands the piezoelectric element PE and thereby compresses the ink passage 68.

The medium-size ink droplet IPm is formed by decreasing the potential applied to the piezoelectric element PE at a relatively low speed in the ink supply step as shown in FIG. 6. A relatively gentle slope of the decrease in potential slowly expands the ink passage 68 and thus enables a greater amount of ink to be fed from the non-illustrated ink tank.

The high decrease rate of the potential causes an ink interface Me to be pressed significantly inward the nozzle Nz, prior to the ink ejection step as shown in FIG. 5. This reduces the size of the ejected ink droplet. The low decrease rate of the potential, on the other hand, causes the ink interface Me to be pressed only slightly inward the nozzle Nz, prior to the ink ejection step as shown in FIG. 6. This increases the size of the ejected ink droplet. The procedure of this embodiment varies the size of the ejected ink droplet by varying the rate of change in potential in the ink supply step.

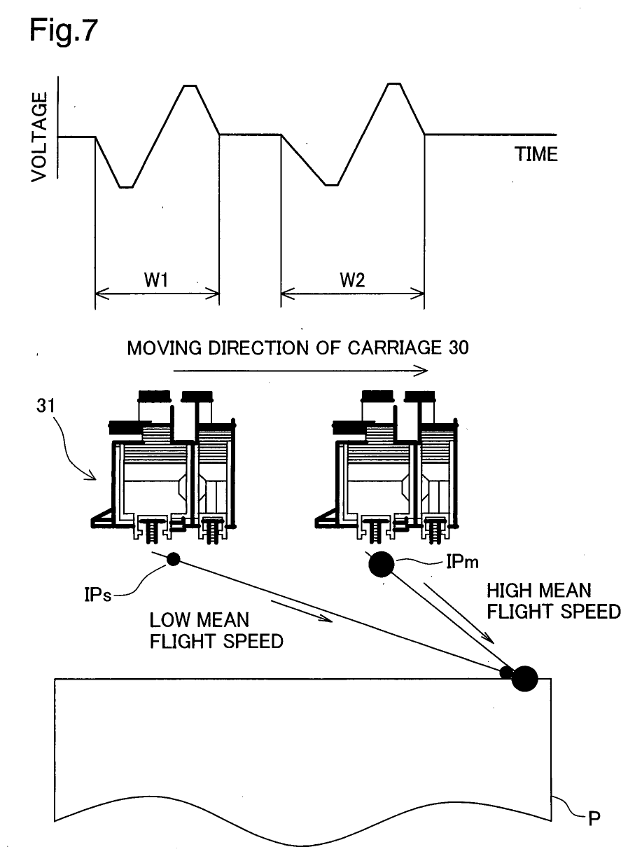

FIG. 7 shows a process of using the small-size and medium-size ink droplets IPs and IPm to form three variable-size dots, that is, large-size, medium-size, and small-size dots, at an identical position. A driving waveform W1 is output to eject the small-size ink droplet IPs, and a driving waveform W2 is output to eject the medium-size ink droplet IPm. As clearly understood from FIG. 6, in the structure of this embodiment, the driving waveform W2 for ejection of the medium-size ink droplet IPm is output after a predetermined time period elapsed since output of the driving waveform W1 for ejection of the small-size ink droplet IPs.

The two driving waveforms W1 and W2 are output to the piezoelectric element PE at these timings, so that the medium-size ink droplet IPm reaches the same hitting position as the hitting position of the small-size ink droplet IPs. As clearly shown in FIG. 7, ejection of the medium-size ink droplet IPm having a relatively high mean flight speed after the predetermined time period elapsed since ejection of the small-size ink droplet IPs having a relatively low mean flight speed enables the two variable-size ink droplets IPs and IPm to reach at substantially the same hitting positions. The mean flight speed represents the average value of flight speed from ejection to hitting against printing paper and decreases with an increase in speed reduction rate.

In the color printer 20 having the hardware Configuration described above, as the printing paper P is transported by the paper feed motor 22, the carriage 30 is reciprocated by the carriage motor 24 while at the same time driving the piezo elements of the print head 10 to eject ink drops of each color and form large-size, medium-size, and small-size dots, producing on the printing paper P an image optimized for the ocular system and the color printer 20.

### B. Print Data Generation Process in Embodiments of Present Invention

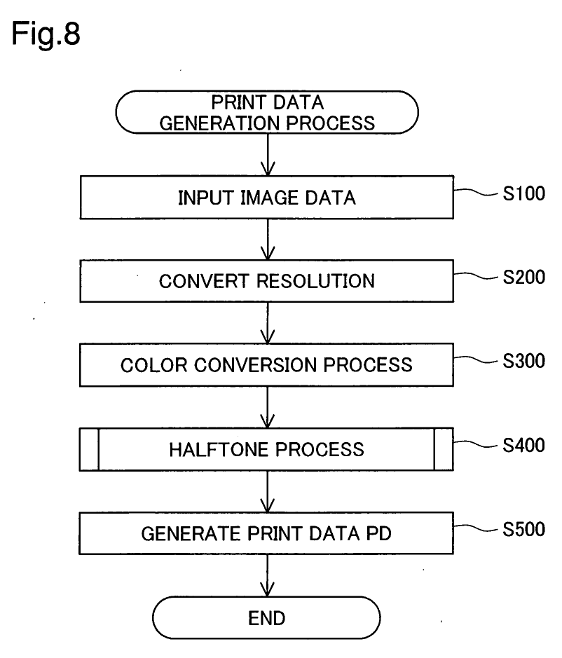

FIG. 8 is a flowchart showing a routine of a print data generation process in the embodiment of the present invention. The print data generation process is a process that is executed by the computer 90 for the purpose of generating print data PD to be supplied to the color printer 20.

In step S100, the printer driver 96 (FIG. 1) is input with image data from the application program 95. The input process is performed in response to a print instruction given by the application program 95. Here, the image data is RGB data.

In step S200, the resolution conversion module 97 converts a resolution of input RGB image data (i.e. a number of pixels per unit length) into a predetermined resolution.

In step S300, the color conversion module 98 converts, on a pixel-by-pixel basis, the RGB image data into multi-tone data of colors available in the color printer 20, with reference to the color conversion table LUT (FIG. 1).

In step S400, the halftone module 99 performs a halftone process. The halftone process is a process of reducing a number of tones of the multi-tone data, i.e. 256, into four, i.e. a number of tones that can be represented on each pixel by the color printer 20 (subtractive color process). In the present embodiment, the four tones are represented as “no dot formed”, “small-size dot formed”, “medium-size dot formed”, and “large-size dot formed”, respectively.

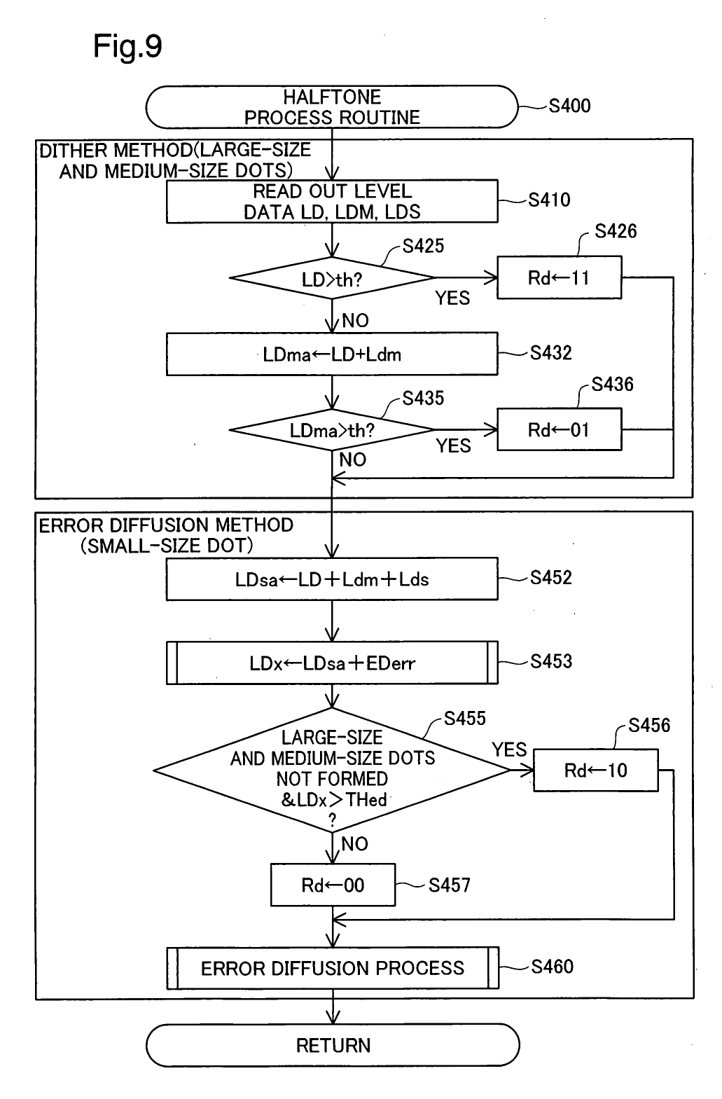

FIG. 9 is a flowchart showing the flow of the halftone process in the embodiment of the present invention. In this halftone process, dot on/off states of large-size dot and medium-size dot are determined by using a specific dither method which will be described later. On the other hand, dot on/off state of small-size dot is determined by using an error diffusion method after the dot on/off states of large-size dot and medium-size dot are determined, based on these determined dot on/off states and a dot recording rate of small-size dot. The process is performed in such sharing and sequence due to the following reasons.

The reason the process is performed in such sharing (large-size dot and medium-size dot are processed by the dither method and small-size dot is processed by the error diffusion method) is that the specific dither method (which will be described later) newly created by the inventors can produce a remarkable effect and thereby accomplish high image quality in shadow regions having medium to high levels of dot densities, but can only produce a relatively small effect in highlight regions having small dot densities represented by small-size dot. Here, the “dot density” represents a product of a dot recording rate and a dot area.

In other words, the feature of the specific dither method is that in case where a print image is generated by mutually combining each of dot groups having physical difference in process of dot formation (e.g. difference of main scanning direction along which dots are formed) in a common print region, degradation of image quality attributable to such combination can be reduced. Such feature can produce a remarkable effect if dot density of each dot group is large such that interaction between the dot groups affects image quality, but no remarkable effect can be obtained if dot density of each dot group is small such that interaction between the dot groups does not affect image quality. Accordingly, as a result of placing emphasis on excellence of dispersion of dots making up a print image, the error diffusion method is employed to determine dot on/off state of small-size dot.

The reason the process is performed in such sequence (the dither method first, then followed by the error diffusion method) is that, as will be described later, in the error diffusion method executed in the embodiment of the present invention, dot on/off state of small-size dot is determined in consideration of dot on/off states of large-size dot and medium-size dot, so that mutual dispersion of dots among large-size dot, medium-size dot, and small-size dot can be improved. Concrete content of the process is as described below.

In step S410, the halftone module 99 (FIG. 1) reads level data LD, LDm, LDs of large-size dot, medium-size dot, and small-size dot out of a recording rate table DT, respectively. The level data represents data obtained by converting each of recording rates of large-size dot, medium-size dot, and small-size dot into 256 scales of data ranging from 0 to 255.

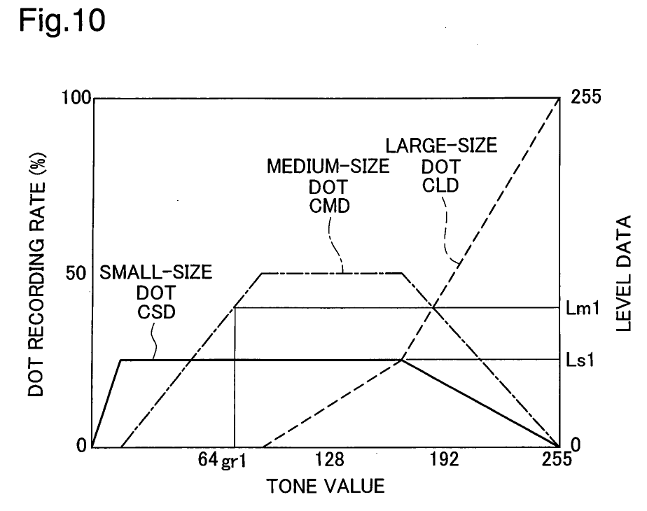

FIG. 10 is an illustration showing the recording rate table DT that is used for determination of the level data of three different dot sizes i.e. large-size dot, medium-size dot, and small-size dot. Tone value (0 to 255), dot recording rate (%), and level data (0 to 255) are respectively shown on the horizontal axis, the left-side longitudinal axis, and the right-side longitudinal axis of the recording rate table DT. Here, the “dot recording rate” represents a percentage of pixels that have dots formed thereon out of entire pixels when a uniform region is reproduced according to a fixed tone value. In FIG. 10, the curve CSD represents the recording rate of small-size dot, the curve CMD represents the recording rate of medium-size dot, and the curve CLD represents the recording rate of large-size dot, respectively.

The reason neither the dot recording rate of small-size dot nor the dot recording rate of medium-size dot has reached 100% is for suppression of banding. On the other hand, since the “dot density” represents a product of a dot recording rate and a dot area, together with the fact that the dot recording rate of small-size dot has an upper limit, any region represented by small-size dot will always represent a region of small dot density (a highlight region).

The level data LD is data obtained by converting the dot recording rate of large-size dot, the level data ldm is data obtained by converting the dot recording rate of medium-size dot, and the level data lds is data obtained by converting the dot recording rate of small-size dot, respectively. For example, in the example shown in FIG. 10, in case where the tone value of multi-tone data is gr1, the level data of large-size dot LD is found to be zero by using the curve CLD, the level data of medium-size dot Ldm is found to be Lm1 by using the curve CMD, and the level data of small-size dot Lds is found to be Ls1 by using the curve CSD.

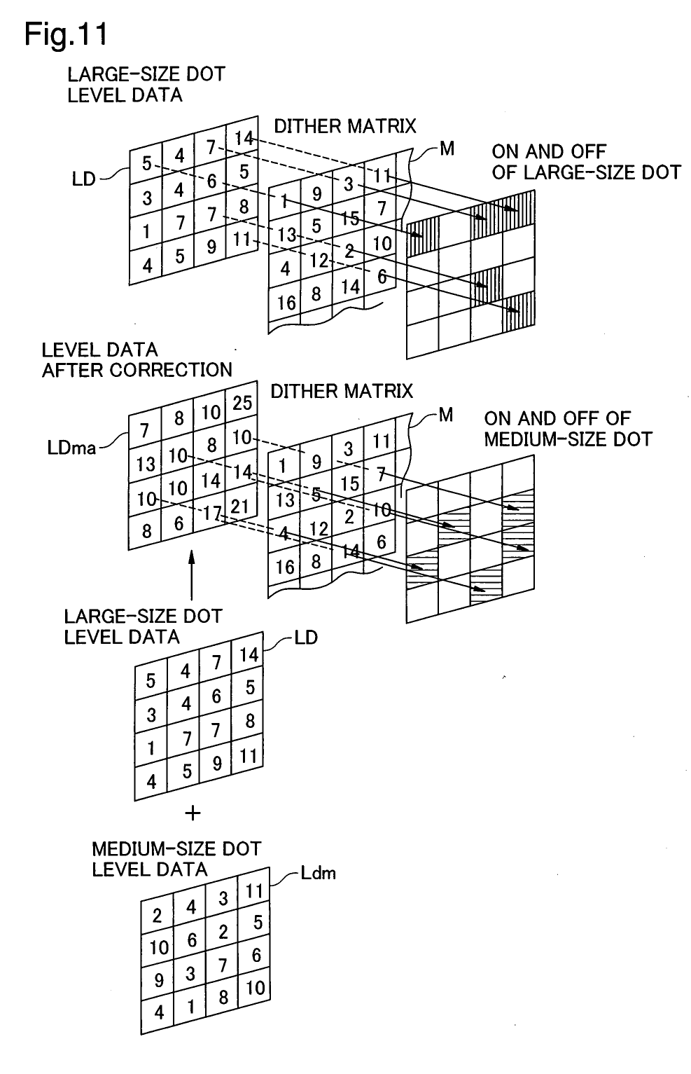

FIG. 11 is an illustration showing the principle of dot on-off determination according to the dither method in the embodiment of the present invention. In the present embodiment, dot on/off state of large-size dot and then dot on/off state of medium-size dot are initially determined by using the dither method based on the level data LD and the level data Ldm, respectively. Once step S410 is thus complete, the control of the process is passed to step S425.

In step S425, the level data LD that was read out in step S410 is compared to a threshold value th. The threshold value th is a value that was read out of a dither matrix M optimized in a manner described later. As a result of the comparison, if the level data LD is greater than the threshold value th, then binary data of “11” is substituted into a result value Rd that indicates formation of dot (step S426). Each bit of the result value Rd corresponds to on or off of the driving waveforms W1 and W2 shown in FIG. 7. On the other hand, if the level data LD is less than the threshold value th, it is determined that large-size dot is not to be formed, and at the same time, the control of the process is passed to step S432 for determination of dot on/off states of medium-size dot and small-size dot.

In step 432, the halftone module 99 calculates adjusted level data for medium-size dot LDma by adding the level data for medium-size dot Ldm, which was read out in step S410, to the level data for large-size dot LD (FIG. 11).

In step S435, the adjusted level data for medium-size dot LDma is compared to a threshold value th. The threshold value th is the same value as the threshold value that was used for the determination of dot on/off state of large-size dot (FIG. 11). As a result of the comparison, if the adjusted level data for medium-size dot LDma is greater than the threshold value th, binary data of “01” is substituted into a result value Rd that indicates formation of dot (step S436). On the other hand, if the adjusted level data for medium-size dot LDma is less than the threshold value th, it is determined that medium-size dot is not to be formed, and at the same time, the control of the process is passed to step S452 for determination of dot on/off state of small-size dot.

In step S452, the halftone module 99 calculates adjusted level data for small-size dot LDsa by adding the level data for small-size dot Lds, which was read out in step S410, to the adjusted level data for medium-size dot LDma (i.e. the level data for large-size dot LD plus the level data for medium-size dot Ldm).

In step S453, an diffusion error EDerr, which is diffused to a target pixel from a plurality of other pixels already processed, is read in and is added to the adjusted level data for small-size dot LDsa. Correction data LDx is thereby generated, which is then used for dot on/off determination (step S455) in the error diffusion method.

In step S455, the halftone module 99 determines whether or not small-size dot is to be formed on the target pixel targeted for determination of dot on/off state of small-size dot, based on the dot on/off states of large-size dot and medium-size dot and on the magnitude relationship between the correction data LDx and a threshold value for error diffusion THed. Specifically, if both large-size dot and medium-size dot are determined not to be formed and the correction data LDx is determined to be greater than the threshold value for error diffusion THed, then it is determined that small-size dot is to be formed and the control of the process is passed to step S456. On the other hand, if either one of large-size dot and medium-size dot is determined to be formed, or alternatively, if the correction data LDx is determined to be equal to or less than the threshold value for error diffusion THed, then it is determined that small-size dot is not to be formed and the control of the process is passed to step S457.

In step S456, binary data of “10” (small-size dot is to be formed) is substituted into a result value Rd that indicates formation of dot. On the other hand, in step S457, binary data of “00” (none of large-size size, medium-size dot, and small-size dot is to be formed) is substituted into a result value Rd that indicates formation of dot. In this way, once dot on/off states are determined for all sizes of dots, i.e. large-size dot, medium-size dot, and small-size dot, the control of the process is passed to an error diffusion process (step S460).

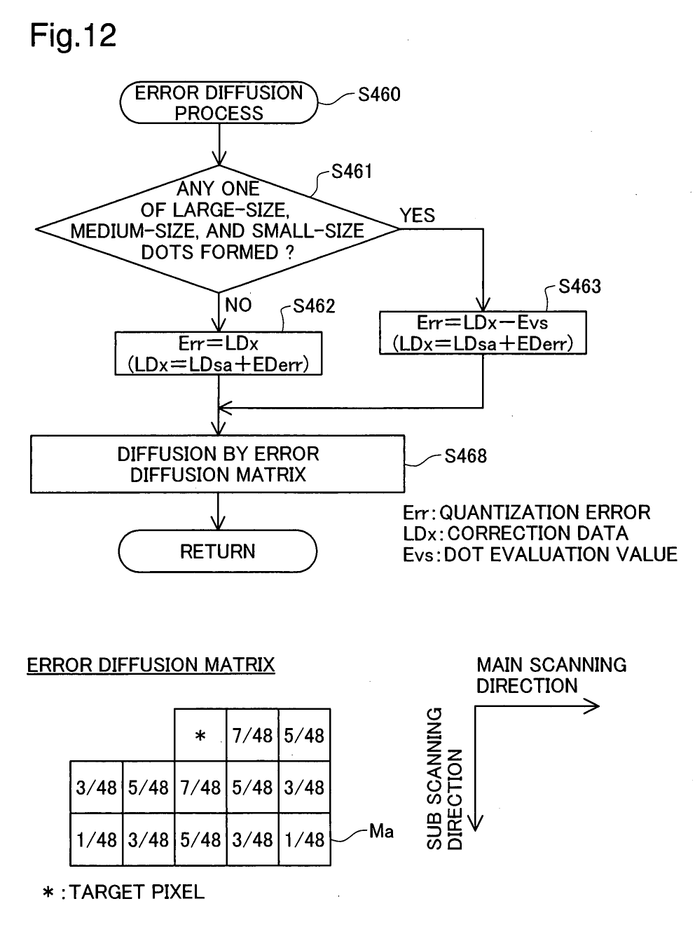

FIG. 12 is an illustration showing a flowchart of an error diffusion method in the embodiment of the present invention. The error diffusion method has a feature that dot on/off state of small-size dot is determined in consideration of dot on/off states of large-size dot and medium-size dot and thus mutual dispersion of dots among large-size dot, medium-size dot, and small-size dot can be improved. Specifically, such feature is accomplished by the following process.

In step S461, the halftone module 99 branches the control of the process according to whether or not any of large-size dot, medium-size dot, and small-size dot has been formed. If none of large-size dot, medium-size dot, and small-size dot has been formed, the control of the process is passed to step S462. On the other hand, if any one of large-size dot, medium-size dot, and small-size dot has been formed, the control of the process is passed to step S463.

In step S462, the halftone module 99 calculates a quantization error Err from the correction data LDx. The quantization error Err is a value of error that is generated as a difference between level data that should be represented according to the correction data LDx (0 to 255) and a level that is actually represented by formation of dot (0 or 255). In step S462 (none of large-size dot, medium-size dot, and small-size dot has been formed), the quantization error Err is equal to the correction data LDx since a dot evaluation value Evs, i.e. the level actually represented by formation of dot, is “0”.

In step S463, the halftone module 99 calculates the quantization error Err by subtracting the dot evaluation value Evs from the correction data LDx. In the present embodiment, the dot evaluation value Evs is set at a maximum level of “255” irrespective of the size of dot formed. In this way, in the present embodiment, the quantization error is calculated in consideration of not only dot on/off state of small-size dot but also dot on/off states of large-size dot and medium-size dot, so that mutual dispersion of dots can be improved not only among small-size dots but also among large-size dot, medium-size dot, and small-size dot. For example, in case where the correction data LDx has a level of “223” and the level considered actually generated by formation of either large-size dot, medium-size dot, or small-size dot is 255, then the quantization error Err is “−32” (=223-255).

In step S468, the halftone module 99 diffuses the quantization error Err thus calculated to neighboring pixels not processed yet. In the present embodiment, the diffusion of error is performed by using a well-known error diffusion matrix of Jarvis, Judice & Ninke type. Specifically, to a pixel to the immediate right hand neighbor of the target pixel, a value “−224/48” (=−32×7/48) is diffused, which is obtained by multiplying the quantization error Err “−32” produced at the target pixel by a coefficient of “7/48” corresponding to the immediate right hand neighbor in an error diffusion entire matrix Ma. Furthermore, to a pixel to the right hand neighbor of the target pixel but one, a value “−160/48” (=−32×5/48) is diffused, which is obtained by multiplying the quantization error Err “−32” produced at the target pixel by a coefficient of “5/48” corresponding to the right hand neighbor but one in the error diffusion entire matrix Ma.

The quantization errors thus diffused are accumulated at each unprocessed pixel to give a diffusion error EDerr, which is used for generation of correction data LDx at the time the unprocessed pixel became the target pixel (step S543 in FIG. 9).

Once the halftone process (FIG. 9) is thus complete with respect to all pixels, the control of the process is passed to step S500 (FIG. 8). In step S500, print data PD is generated based on the dot on/off states of large-size dot, medium-size dot, and small-size dot that were determined with respect to each pixel.

As described above, in the present embodiment, with respect to medium-size dot and large-size dot that are used to represent tone ranges of relatively large dot densities, dot on/off state is determined by employing a specific dither method that can reduce degradation of image quality caused by mutually combining each of dot groups having physical difference in process of dot formation in a common print region to generate a print image, and subsequently, with respect to small-size dot that is used to represent highlight regions of relatively small dot densities, dot on/off state is determined by employing an error diffusion method that can improve mutual dispersion of dots among large-size dot, medium-size dot, and small-size dot. Accordingly, it is possible to realize a halftone process that can reduce the above-described degradation of image quality while providing good mutual dispersion of dots among large-size dot, medium-size dot, and small-size dot.

Although in the present embodiment, it is assumed that three sizes of dots, i.e. large-size dot, medium-size dot, and small-size dot can be formed; however, the present invention would also be applicable to other cases such as two types of dots can be formed or four or more types of dots can be formed. Furthermore, although a halftone process is performed by employing a dither method with respect to large-size dot and medium-size dot and by employing an error diffusion method with respect to small-size dot among the three sizes of dots i.e. large-size dot, medium-size dot, and small-size dot in the present embodiment, it would also be acceptable to perform a halftone process by employing a dither method with respect to large-size dot and by employing an error diffusion method with respect to medium-size dot and small-size dot. In addition, the error diffusion method described above can be realized not only in combination with the specific dither method but may also be realized in combination with any other commonly-used general dither method.

Additionally, in the present embodiment, the diffusion of error is performed under assumption that small-size dot is formed if it is determined by the dither method that large-size dot or medium-size dot is formed. It is therefore possible to easily realize a halftone process in consideration of mutual dispersion between larger-size dot and smaller-size dot. However, dot sizes are not considered in this dispersion of dots. On the other hand, in the error diffusion process, it would also be acceptable to use an input tone value rather than a dot recording rate of small-size dot, and represent dot evaluation values of large-size dot, medium-size dot, and small-size dot by using the input tone value. In this way, it is possible to improve mutual dispersion of dots in consideration of dot sizes as well.

### C. Optimized Dither Matrix Generation Method in the Embodiments

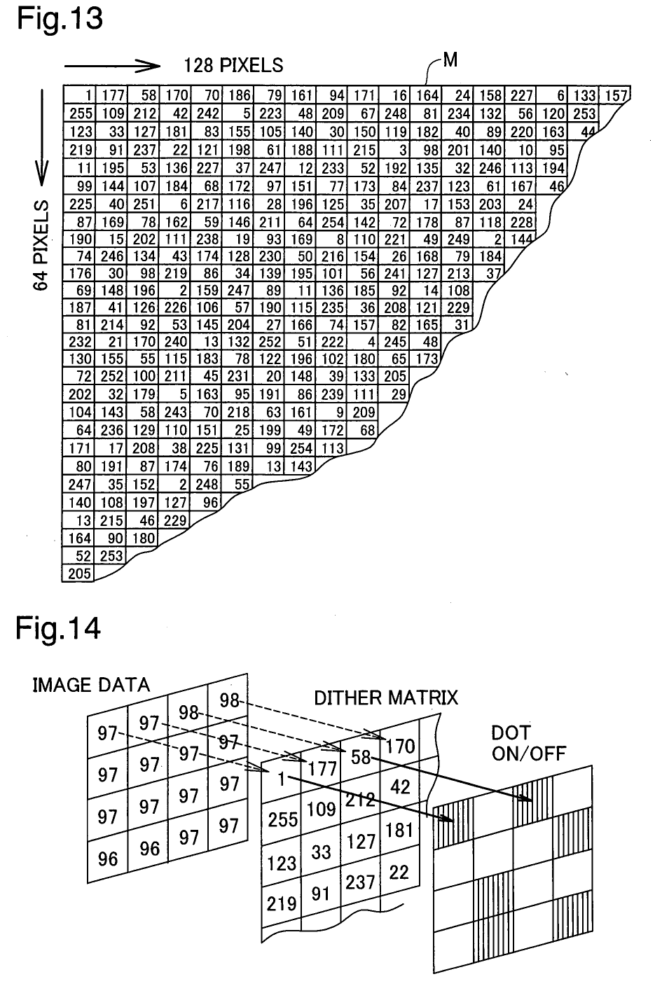

FIG. 13 is an illustration depicting conceptually part of an exemplary dither matrix. The illustrated dither matrix contains threshold values selected evenly from a tone value range of 1 to 255, stored in a total of 8912 elements, i.e. 128 elements in the horizontal direction (main scanning direction) and 64 elements in the vertical direction (sub scanning direction). The size of the dither matrix is not limited to that shown by way of example in FIG. 13; various other sizes are possible, including matrices having identical numbers of horizontal and vertical elements.

FIG. 14 is an illustration depicting the concept of dot on/off states using a dither matrix. For convenience in illustration, only a portion of the elements are shown. As depicted in FIG. 14, when determining dot on/off states, tone values contained in the image data are compared with the threshold values saved at corresponding locations in the dither matrix. In the event that a tone value contained in the image data is greater than the corresponding threshold value stored in the dither table, a dot is formed; if the tone value contained in the image data is smaller, no dot is formed. Pixels shown with hatching in FIG. 14 signify pixels targeted for dot formation. By using a dither matrix in this way, dot on-off states can be determined on a pixel-by-pixel basis, by a simple process of comparing the tone values of the image data with the threshold values established in the dither matrix, making it possible to carry out the tone number conversion process rapidly. Furthermore, once image data tone values have been determined, decisions as to whether to form dots on pixels will be made exclusively on the basis of the threshold values established in the matrix, and from this fact it will be apparent that with a systematic dither process it is possible to actively control dot production conditions by means of the threshold value storage locations established in the dither matrix.

Since with a systematic dither process it is possible in this way to actively control dot production conditions by means of the storage locations of the threshold values established in the dither matrix, a resultant feature is that dot dispersion and other picture qualities can be controlled by means of adjusting the settings of the threshold value storage locations. This means that by means of a dither matrix optimization process, it is possible to optimize the halftoning process for a wide variety of target states.

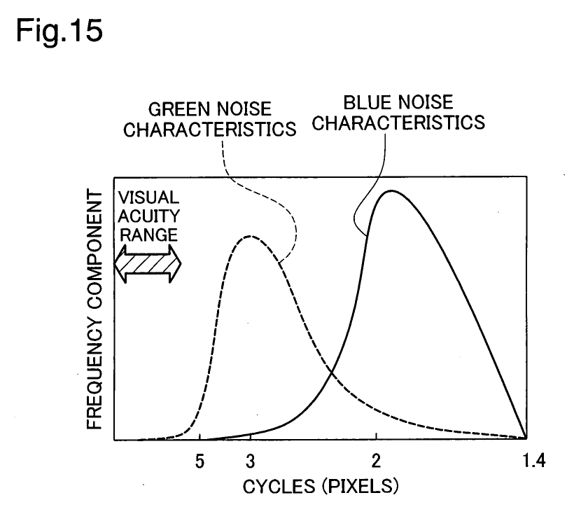

FIG. 15 is an illustration depicting conceptually exemplary spatial frequency characteristics of threshold values established at pixels in a blue noise dither matrix having blue noise characteristics, by way of a simple example of adjustment of dither matrix. The spatial frequency characteristics of a blue noise dither matrix are characteristics such that the length of one cycle has the largest frequency component in a high frequency region of close to two pixels. These spatial frequency characteristics have been established in consideration of the characteristics of human visual perception. Specifically, a blue noise dither matrix is a dither matrix in which, in consideration of the fact that human visual acuity is low in the high frequency region, the storage locations of threshold values have been adjusted in such a way that the largest frequency component is produced in the high frequency region.

FIG. 15 also shows exemplary spatial frequency characteristics of a green noise matrix, indicated by the broken line curve. As illustrated in the drawing, the spatial frequency characteristics of a green noise dither matrix are characteristics such that the length of one cycle has the largest frequency component in an intermediate frequency region of from two to ten or so pixels. Since the threshold values of a green noise dither matrix are established so as to produce these sorts of spatial frequency characteristics, if dot on/off states of pixels are decided while looking up in a dither matrix having green noise characteristics, dots will be formed adjacently in units of several dots, while at the same time the clusters of dots will be formed in a dispersed pattern overall. For printers such as laser printers, with which it is difficult to consistently form fine dots of about one pixel, by means of deciding dot on/off states of pixels through lookup in such a green noise matrix it will be possible to suppress formation of “orphan” dots. As a result, it will be possible to output images of consistently high quality at high speed. In other words, a dither matrix adapted for lookup to decide dot on/off states in a laser printer or similar printer will contain threshold values adjusted so as to have green noise characteristics. These types of characteristics correspond to “a first predetermined characteristic” in this embodiment. Note that in this specification, the terms “blue noise characteristics” and “green noise characteristics” have meanings as defined in Robert Ulichney “Digital halftoning”.

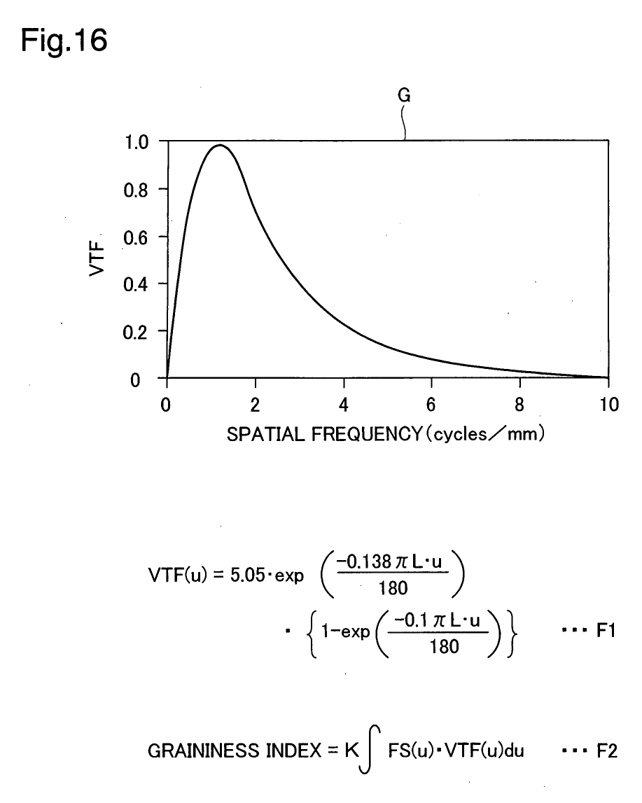

FIG. 16 shows conceptual illustrations of a visual spatial frequency characteristic VTF (Visual Transfer Function) representing human visual acuity with respect to spatial frequency. Through the use of a visual spatial frequency characteristic VTF it will be possible to quantify the perception of graininess of dots apparent to the human visual faculty following the halftone process, by means of modeling human visual acuity using a transfer function known as a visual spatial frequency characteristic VTF. A value quantified in this manner is referred to as a graininess index. Formula F1 gives a typical experimental equation representing a visual spatial frequency characteristic VTF. In Formula F1 the variable L represents observer distance, and the variable u represents spatial frequency. Formula F2 gives an equation defining a graininess index. In Formula F2 the coefficient K is a coefficient for matching derived values with human acuity.

Such quantification of graininess perception by the human visual faculty makes possible fine-tuned optimization of a dither matrix for the human visual system. Specifically, a Fourier transform can be performed on a dot pattern hypothesized when input tone values have been input to a dither matrix, to arrive at a power spectrum FS; and a graininess evaluation value that can be derived by integrating all input tone values after multiplying the power spectrum FS with the visual spatial frequency characteristic VTF (Formula F2) can be utilized as a evaluation coefficient for the dither matrix. In this example, the aim is to achieve optimization by adjusting threshold value storage locations to minimize the dither matrix evaluation coefficient.

The feature that is common to such dither matrices established in consideration of the characteristics of human visual perception such as the blue noise matrix and the green noise matrix is that, on a printing medium, an average value of components within a specified low frequency range is set small, where the specified low frequency range is a spatial frequency domain within which visual sensitivity of human is at a highest level and ranges from 0.5 cycles per millimeter to 2 cycles per millimeter with a central frequency of 1 cycle per millimeter. For example, the inventors have ascertained that, by configuring a matrix to have such frequency characteristic that the average value of components within the specified low frequency range is smaller than an average value of components within another frequency range, where the another frequency range is a domain within which visual sensitivity of human is reduced to almost zero and ranges from cycles per millimeter to 20 cycles per millimeter with a central frequency of 10 cycles per millimeter, it is possible to reduce granularity in a domain within which visual sensitivity of human is at a high level, thereby effectively improving image quality with a focus on visual sensitivity of human.

However, in the conventional dither matrices, no consideration has been given to degradation of image quality caused by performing a plural times of scans to form ink dots in a common region on a printing medium to print an image.

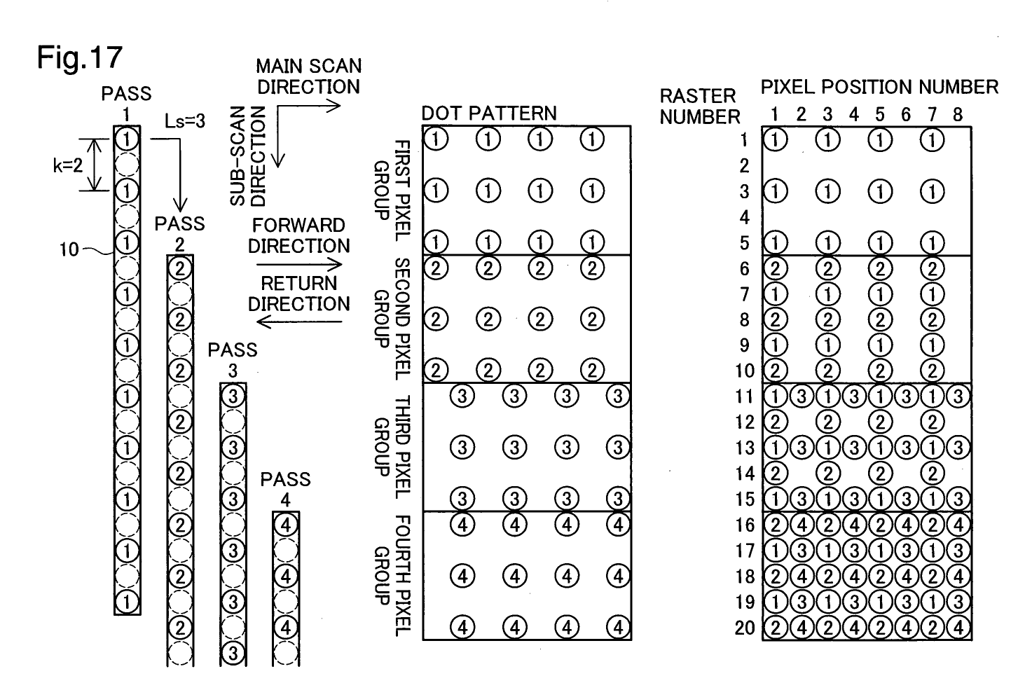

FIG. 17 is an illustration of an exemplary print image generating process in the embodiments. In this image forming methods, the print image is generated on the printing medium by forming black ink dots while performing main scan and sub scan for easy-to-follow explanation. The main scan means the operation of moving the printing head 10 (FIG. 3) relatively in the main scanning direction in relation to the printing medium. The sub scan means the operation of moving the printing head 10 relatively in the sub scanning direction in relation to the printing medium. The printing head 10 is configured so as to form ink dots by spraying ink drops on the printing medium. The printing head 10 is equipped with ten nozzles that are not illustrated at intervals of 2 times the pixel pitch k.

Generation of the print image is performed as follows while performing main scan and sub scan. Among the ten main scan lines of raster numbers 1, 3, 5, 7, 9, 11, 13, 15, 17, and 19, ink dots are formed at the pixels of the pixel position numbers 1, 3, 5, and 7. The main scan line means the line formed by the continuous pixels in the main scanning direction. Each circle indicates the dot forming position. The number inside each circle indicates the pixel groups configured from the plurality of pixels for which ink dots are formed simultaneously. With pass 1, dots are formed on the print pixels belong to the first pixel group.

When the pass 1 main scan is completed, the sub scan sending is performed at a movement volume Ls of 3 times the pixel pitch in the sub scanning direction. Typically, the sub scan sending is performed by moving the printing medium, but with this embodiment, the printing head 10 is moved in the sub scanning direction to make the description easy to understand. When the sub scan sending is completed, the pass 2 main scan is performed.

With the pass 2 main scan, among the ten main scan lines for which the raster numbers are 6, 8, 10, 12, 14, 16, 18, 20, 22, and 24, ink dots are formed at the pixels for which the pixel position number is 1, 3, 5, and 7. Working in this way, with pass 2, dots are formed on the print pixels belonging to the second pixel group. Note that the two main scan lines for which the raster numbers are 22 and 24 are omitted in the drawing. When the pass 2 main scan is completed, after the sub scan sending is performed in the same way as described previously, the pass 3 main scan is performed.

With the pass 3 main scan, among the ten main scan lines including the main scan lines for which the raster numbers are 11, 13, 15, 17, and 19, ink dots are formed on the pixels for which the pixel position numbers are 2, 4, 6, and 8. With the pass 4 main scan, among the ten main scan lines including the three main scan lines for which the raster numbers are 16, 18, and 20, ink dots are formed on the pixels for which the pixel position numbers are 2, 4, 6, and 8. Working in this way, we can see that it is possible to form ink dots without gaps in the sub scan position from raster number 15 and thereafter. With pass 3 and pass 4, dots are formed on the print pixels belonging respectively to the third and fourth pixel groups.

When monitoring this kind of print image generation with a focus on a fixed region, we can see that this is performed as noted below. For example, when the focus region is the region of pixel position numbers 1 to 8 with the raster numbers 15 to 19, we can see that the print image is formed as noted below at the focus region.

With pass 1, at the focus region, we can see that a dot pattern is formed that is the same as the ink dots formed at the pixel positions for which the pixel position numbers are 1 to 8 with the raster numbers 1 to 8. This dot pattern is formed by dots formed at the pixels belonging to the first pixel group. Specifically, with pass 1, for the focus region, dots are formed at pixels belonging to the first pixel group.

With pass 2, at the focus region, dots are formed at the pixels belonging to the second pixel group. With pass 3, at the focus region, dots are formed at the pixels belonging to the third pixel group. With pass 4, at the focus region, dots are formed at the pixels belonging to the fourth pixel group.

In this way, the monochromatic print with this embodiment, we can see that the dots formed at the print pixels belonging to each of the plurality of first to fourth pixel groups are formed by mutually combining in the common print region. Meanwhile, in color printing color print images are formed by means of ejecting ink of the colors C, Mz, Y and K from the ink head (FIG. 3), onto each of the first to fourth multiple pixel groups, in the same manner.

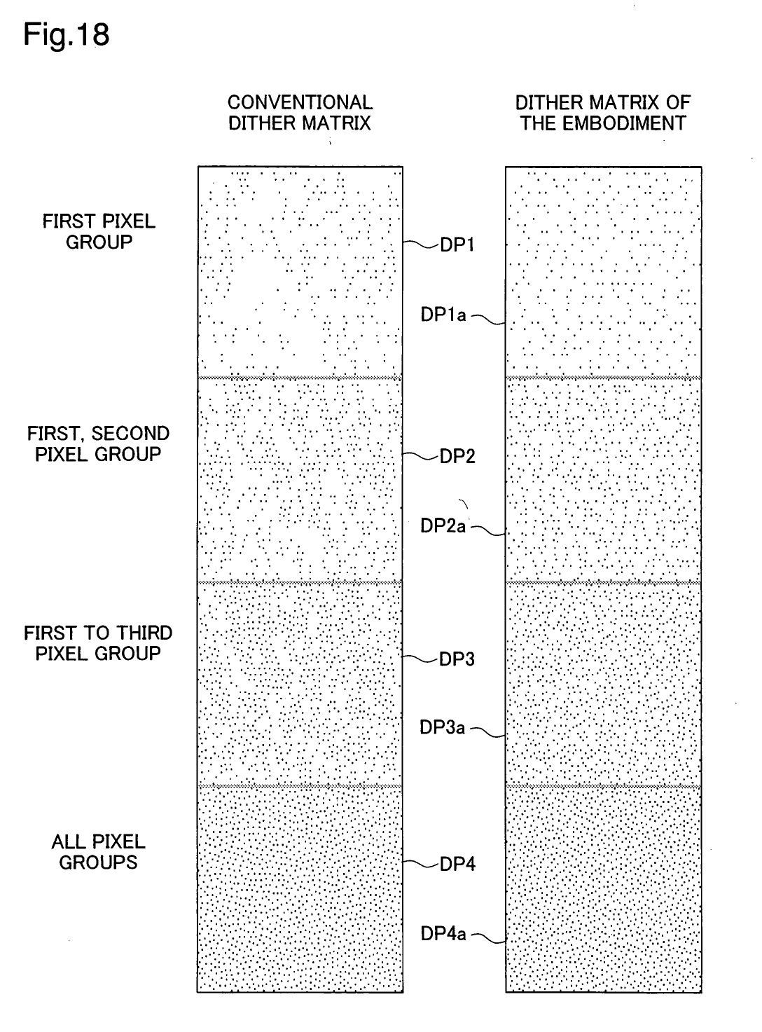

FIG. 18 shows an illustration depicting creation of a print image on a printing medium in the embodiments by means of combining, in a common print region, print pixels that belong to multiple pixel groups. In the example of FIG. 18, the print image is a print image of prescribed intermediate tone (monochrome). The dot patterns DP1, DP1a are dot patterns formed on a plurality of pixels belonging to a first pixel group. The dot patterns DP2, DP2a are dot patterns formed on a plurality of pixels belonging to the first and a second pixel group. The dot patterns DP3, DP3a are dot patterns formed on a plurality of pixels belonging to the first to third pixel groups. The dot patterns DP4, DP4a are dot patterns formed on a plurality of pixels belonging to all of the pixel groups.

The dot patterns DP1, DP2, DP3, DP4 are dot patterns obtained where a conventional dither matrix is used. The dot patterns DP1a, DP2a, DP3a, DP4a are dot patterns obtained where the dither matrix of the embodiment is used. As will be apparent from FIG. 18, where the dither matrix of the embodiment is used, dispersion of dots is more uniform than where a conventional dither matrix is used, especially for the dot patterns DP1a, DP2a having minimal overlap of dot pattern.

Since conventional dither matrices lack the concept of pixel groups, optimization is carried out in a manner focused exclusively on dispersion of dots in the final print image (in the example of FIG. 18, the dot pattern DP4).

However, the inventors have carried out an analysis of image quality of print images, focusing on the dot patterns in the course of the dot formation process. As a result of the analysis, it was found that image irregularity may arise during the dot formation process due to density level of dot patterns. The inventors discovered that such image irregularity occurs because dots of several colors formed during a given main scan pass do not overlap in a uniform manner, thus producing regions in which dots of several colors come into contact and bleed together and regions in which where dots of several colors remain separate and do not bleed together, occur in mottled patterns, which in turn causes irregular color.

Such color irregularity may occur even where a print image is formed in a single pass. However, even if color irregularity is produced uniformly throughout the entire image, it will nevertheless not be readily apparent to the human visual faculty. This is because, due to the fact that the irregularity occurs uniformly, ink bleed will not take the form of non-uniform “irregularity” that includes a low-frequency component.

In a dot pattern composed of pixel groups in which ink dots are formed substantially simultaneously during a given main scan, if irregularity should happen to occur due to ink bleed in a low-frequency region that is readily noticeable to the human eye, marked degradation of image quality will become apparent. In this way, the inventors discovered for the first time that, where a print image is produced by means of forming ink dots, high levels of image quality may be obtained if the dither matrix is optimized by also giving attention to the dot patterns formed in pixel groups in which ink dots are formed substantially simultaneously.

The inventors further ascertained that degraded image quality of an extent highly noticeable to the human eye may result not only from ink bleed, but also from physical phenomena of the ink, such as ink agglomeration, irregular sheen, or bronzing. Bronzing is a phenomenon whereby, due to factors such as coagulation of dye in ink drops, the condition of reflected light on the printed paper surface varies so that, for example, the printed surface develops a bronze-colored appearance depending on the viewing angle.

Furthermore, conventional dither matrices, attempt to achieve optimization on the assumption that positional relationships among pixel groups are the same as the ones posited in advance; thus, in the event that actual positional relationships should deviate, optimality can no longer be assured and appreciable degradation of image quality may result. However, experiments conducted by the inventors have shown for the first time that, with the dither matrix of the embodiment, due to the fact that dispersion of dots is assured in dot patterns within dot groups as well, a high level of robustness against such deviation in positional relationships can be assured.

The inventors have furthermore found that this technical concept assumes increased importance as printing speed increases. This is because faster printing speed means that dots of the next pixel group are formed before there has been sufficient time for the ink to be absorbed.

Based on this standpoint, the inventors of the present application created a dither matrix generation method that can reduce degradation of image quality caused by performing a plural times of scans to form ink dots in a common region on a printing medium to print an image.

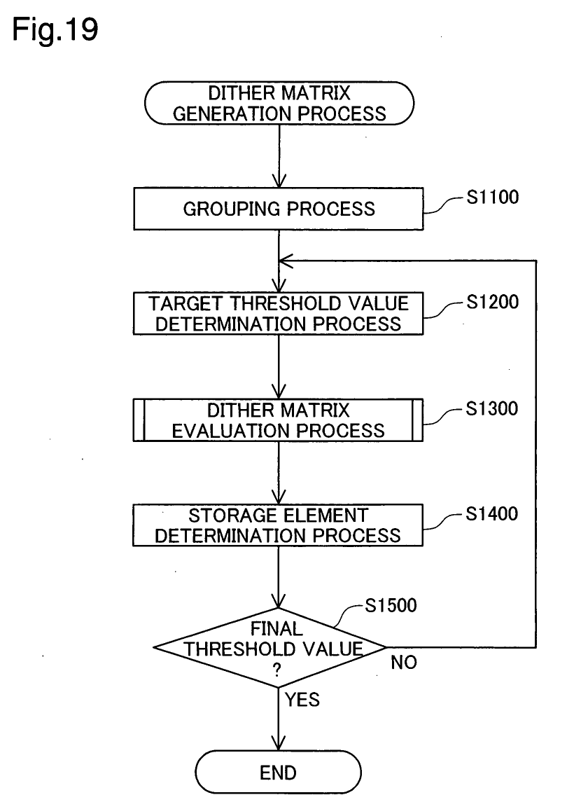

FIG. 19 is a flowchart showing the processing routine of a dither matrix generation method in the embodiment of the present invention. In the dither matrix generation method of the embodiment, it is configured such that optimization can be performed in consideration of dispersion of dots formed by each main scan (pass) in the print image generating process. In this example, a small dither matrix of 8 rows and 8 columns is generated for ease of explanation. As an evaluation value for representing optimality of the dither matrix, a graininess index (Formula F2) is used.

In step S1100, a grouping process is performed. In the present embodiment, the grouping process is a process that divides a dither matrix into groups of elements respectively corresponding to a plurality of pixel groups on each of which dots are formed by each main scan in the print image generating process (FIG. 17).

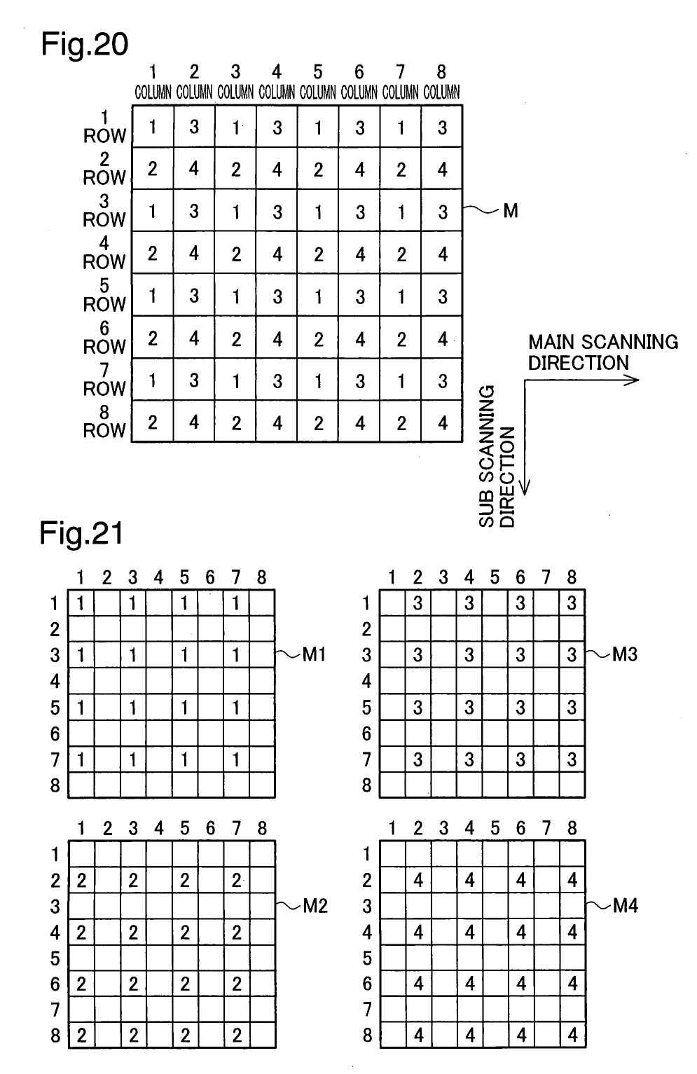

FIG. 20 is an illustration depicting a dither matrix M subjected to the grouping process in the embodiment of the present invention. In this grouping process, the dither matrix M is divided into four pixel groups shown in FIG. 17. Each number marked on each element of the dither matrix M indicates the pixel group to which the element belongs. For example, an element in the first row of the first column belongs to the first pixel group (FIG. 17), and an element in the second row of the first column belongs to the second pixel group.

FIG. 21 is an illustration depicting four divided matrices M1-M4 in the embodiment of the present invention. The divided matrix M1 is composed of: a plurality of elements that correspond to pixels belonging to the first pixel group, among the elements of the dither matrix M; and blank elements i.e. a plurality of elements in blank. The blank element is an element in which no dot is formed irrespective of input tone value. The divided matrices M2, M3, and M4 are respectively composed of: a plurality of elements that correspond to pixels belonging to the second, third, and fourth pixel groups, among the elements of the dither matrix M; and blank elements.

Once the grouping process of step S1100 (FIG. 19) is thus complete, the control of the process is passed to step S1200.

In step S1200, a target threshold value determination process is performed. The target threshold value determination process is a process of determining a threshold value that is targeted for determination of storage element. In the present embodiment, the determination of threshold value is performed by selecting threshold values in ascending order, i.e. in order of decreasing tendency to dot formation. Selecting threshold values in order of decreasing tendency to dot formation allows threshold values to have its storage elements determined in order of decreasing conspicuity of dot graininess, i.e. level of highlight, of regions for which the threshold values are used to control dot arrangements. It is thus possible to provide greater degrees of design freedom to highlight regions having conspicuous dot graininess and relatively small dot density. In this example, it is assumed that eight threshold values have already been determined, as will be described later, and that a ninth threshold value is now to be determined.

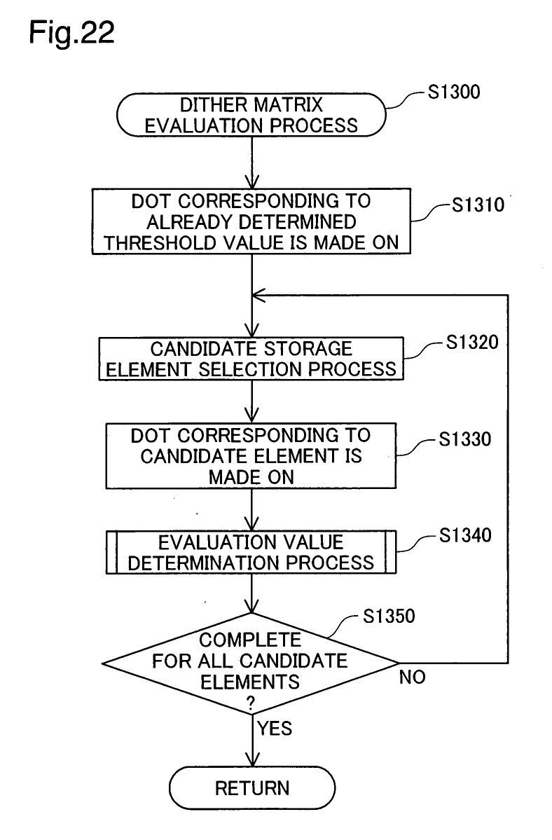

FIG. 22 is a flowchart showing the processing routine of a dither matrix evaluation process in the embodiment of the present invention. In step S1310, each dot that corresponds to an already determined threshold value is made on. The already determined threshold value indicates a threshold value for which a storage element is determined. In the present embodiment, since threshold values are selected in order of decreasing tendency to dot formation as described above, at the time when a dot that corresponds to a target threshold value is formed, every pixel that corresponds to an element storing an already determined threshold value will have a dot formed thereon. To the contrary, in case where an input tone value is a minimum value that allows for formation of dot in association with a target threshold value, any pixel that corresponds to an element other than those storing already determined threshold values will not have a dot formed thereon.

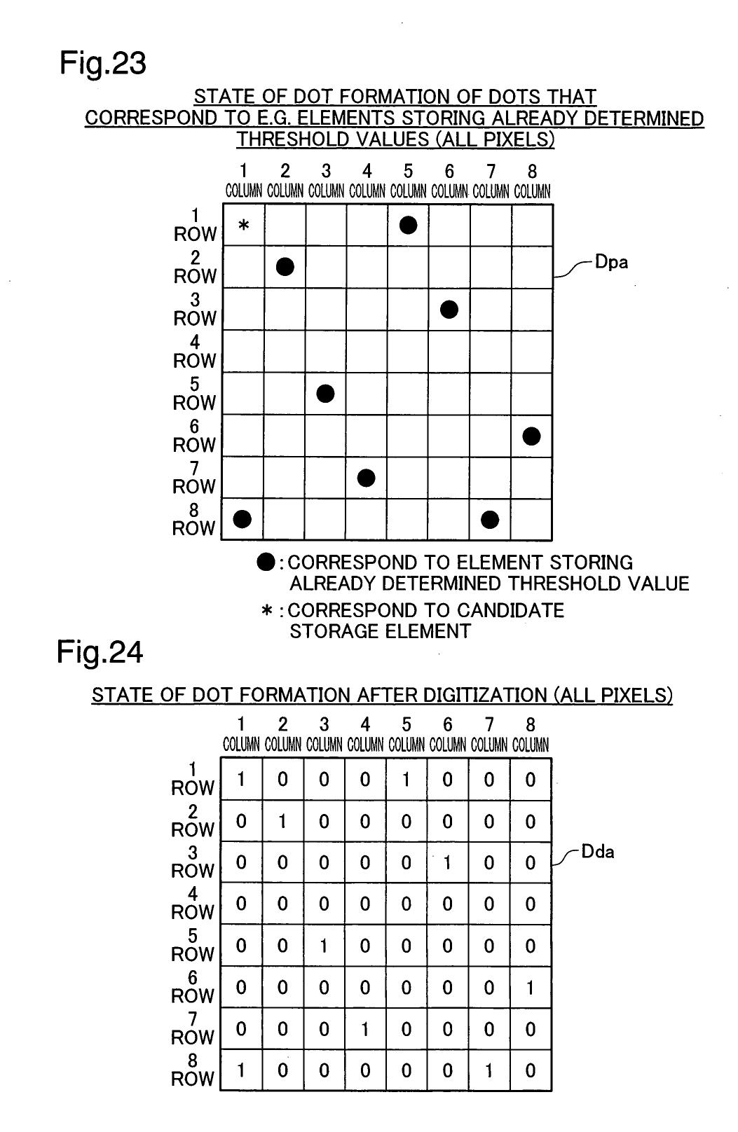

FIG. 23 is an illustration depicting dots formed on each of eight pixels that correspond to elements storing threshold values associated with the first to eighth greatest tendency to dot formation in the dither matrix M. A dot pattern Dpa thus configured is used to determine on which pixel a ninth dot is to be formed. The mark “*” indicates a candidate storage element.

In step S1320 (FIG. 22), a candidate storage element selection process is performed. The candidate storage element selection process is a process of selecting a candidate storage element, i.e. a candidate element for storing a threshold value, out of elements of the divided matrix M1 selected as an evaluation matrix. In this example, a storage element at the first row of the first column attached with the mark “*” is selected as the candidate storage element.

As for the selection of candidate storage element, every storage element other than the eight storage elements already determined as elements for storing threshold values of the dither matrix M may be selected in sequence, or alternatively, any element not adjacent to the already determined elements may be selected preferentially as long as such an element exists.

In step S1330 (FIG. 22), it is assumed that a dot is made on in association with the selected candidate storage element. This allows the dither matrix M to be evaluated in association with the time when a threshold value associated with the ninth greatest tendency to dot formation is stored in the candidate storage element.

FIG. 24 is an illustration depicting a matrix that digitizes a state in which the dot pattern Dpa has been formed, that is to say, a dot density matrix Dda that represents a dot density in a quantitative manner is depicted. The numeral “0” indicates no dot has been formed; whereas the numeral “1” indicates a dot has been formed (including the case where a dot is assumed to be formed).

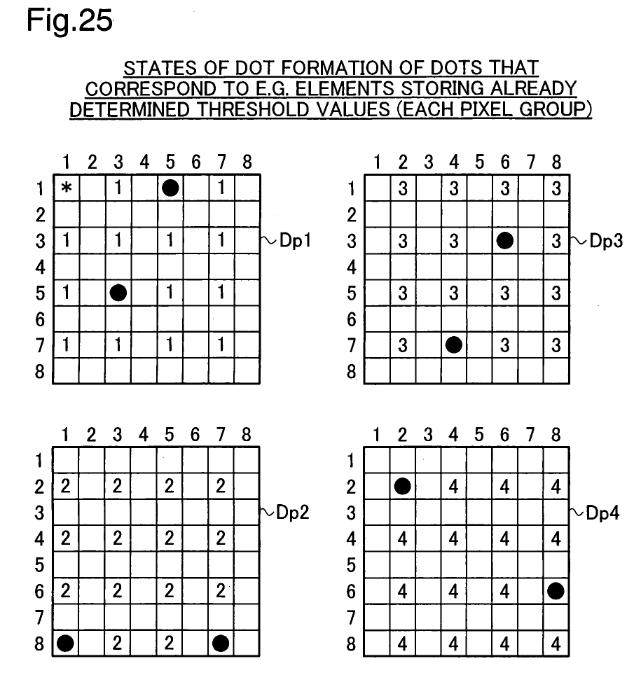

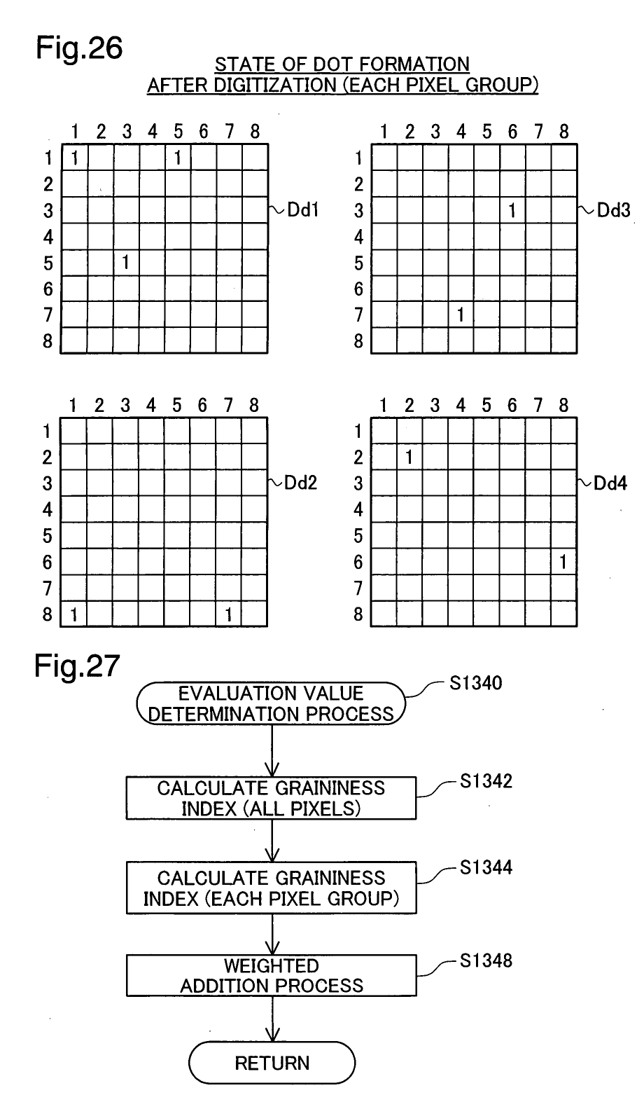

FIG. 25 is an illustration depicting four dot patterns Dp1, Dp2, Dp3, Dp4 formed in print pixels belonging respectively to first to fourth pixel groups, among elements storing the threshold values associated with the first to eighth greatest tendency to dot formation in the dither matrix M. In other words, dot patterns formed on print pixels respectively belonging to first to fourth pixel groups are extracted out of the dot pattern Dpa (FIG. 23) and are depicted in FIG. 25. In FIG. 25, a print pixel that corresponds to a candidate storage element is also indicated by the mark “*”, as in the dot pattern Dpa (FIG. 23). FIG. 26 is an illustration depicting dot density matrices Dd1, Dd2, Dd3, Dd4 that respectively correspond to the four dot patterns Dp1, Dp2, Dp3, Dp4.

Once the five dot density matrices Dda, Dd1, Dd2, Dd3, and Dd4 are thus determined, the control of the process is passed to an evaluation value determination process (step S1340).

FIG. 27 is a flowchart showing the processing routine of the evaluation value determination process in the embodiment of the present invention. In step S1342, a graininess index is calculated by using all pixels as evaluation target. Specifically, a graininess index is calculated by using Formula F2 (FIG. 16), based on the dot density matrix Dda (FIG. 24). In step S1344, graininess indices are respectively calculated by using the first to fourth pixel groups as evaluation targets. Specifically, graininess indices are respectively calculated by using Formula F2 (FIG. 16), based on the dot density matrices Dda, Dd1, Dd2, Dd3, and Dd4.

In step S1348, a weighted addition process is performed. The weighted addition process is a process of assigning weights to the respective calculated graininess indices and then adding them together.

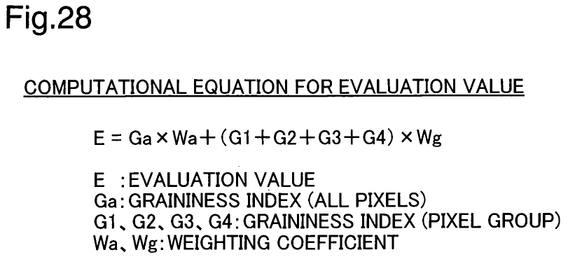

FIG. 28 is an illustration depicting a computational equation for use in the weighted addition process. As can be seen from the computational equation, an evaluation value E is determined as a sum of: a value obtained by multiplying the graininess index Ga regarding all pixels (calculated in step S1342) by a weighting coefficient Wa (four, for example); and a value obtained by multiplying a sum of the four graininess indices G1, G2, G3, G4 respectively regarding the first to fourth pixel groups (calculated in step S1344) by a weighting coefficient Wg (one, for example).

Such series of processes (FIG. 22) from the candidate storage element selection process (step S1320) to the evaluation value determination process (step S1340) is performed for every candidate storage element (step S1350). Once evaluation values are thus determined with respect to all candidate storage elements respectively, then the control of the process is passed to step S1400 (FIG. 19).

In step S1400, a storage element determination process is performed. In the storage element determination process, a candidate storage element that has a minimum evaluation value is determined as the element for storing the target threshold value.

Such processing (from step S1200 to step 1400) is repeated for every threshold value until the processing reaches a last threshold value (step S1500). The last threshold value may be a maximum threshold value associated with the least tendency to dot formation, or alternatively, the last threshold value may be a maximum threshold value within a predetermined range of threshold values set in advance. This also applies to a threshold value that is initially targeted for evaluation. That is to say, such optimization is also applicable to limited threshold value(s).

As described above, in the present embodiment, a dither matrix M is optimized in such a way that reduces graininess indices of a plurality of dot patterns respectively formed by each main scan. It is therefore possible to reduce degradation of image quality attributable to physical phenomenon of ink occurring mutually among the plurality of dot patterns respectively formed by each main scan. The characteristic that graininess index is small in the present embodiment corresponds to the “first predetermined characteristic” in the scope of claim for patent.

### D. Modifications

Although the present invention has been described above in terms of several embodiments, the present invention is not restricted to these embodiments, but may be implemented in various modes without departing from the scope of the present invention. For example, in the present invention, the following modifications are also applicable.

D-1: Although in above embodiments, graininess index is used as a scale of dither matrix evaluation; however, it would also be acceptable to use other scales, such as RMS granularity created by the inventors of the present invention, for example. The RMS granularity can be determined by subjecting dot density values to a low pass filtering process using a predetermined low pass filter and then calculating a standard deviation of the density values after the low pass filtering process. Furthermore, a potential method may be employed as well, which stores threshold values into elements in order of increasing dot densities of corresponding pixels after the low pass filtering process. The characteristic that graininess index is small in this modification corresponds to the “first predetermined characteristic” in the scope of claim for patent.

D-2: Although in above embodiments, the evaluation process is performed each time a storage element for storing a threshold value is determined; however, the present invention would also be applicable to cases where storage elements for storing a plurality of threshold values are determined simultaneously at one time, for example. Specifically, for example, in case where storage elements of first to sixth threshold values have been determined and storage elements of seventh and eighth threshold values are now to be determined in above embodiments, storage elements of the seventh and eighth threshold values may be determined based on an evaluation value associated with the time a dot has been added to a storage element of the seventh threshold value and an evaluation value associated with the time dots have respectively been added to storage elements of the seventh and eighth threshold values, or alternatively, only a storage element of the seventh threshold value may be determined.

D-3: Although in above embodiments, optimality of dither matrix is evaluated based on graininess index, RMS granularity, and the like; however it would also be acceptable to evaluate optimality of dither matrix by subjecting dot patterns to Fourier transformation as well as by using VTF function. Specifically, it would be acceptable to apply an evaluation scale used by Dooley et al. of Xerox Corporation (GS value: Grainess scale) to dot patterns and evaluate optimality of dither matrix by using the GS value. Here, the GS value is a graininess evaluation value that can be obtained by: digitizing dot patterns by performing predetermined processing including two-dimensional Fourier transformation; performing filtering processing of multiplying them by a visual spatial frequency characteristic VTF; and integrating them thereafter. The characteristic that GS value is small in this modification corresponds to the “first predetermined characteristic” in the scope of claim for patent.

D-4: Although in above embodiments, storage elements of threshold values are determined in sequence; however, it would also be acceptable to generate a dither matrix by adjusting a dither matrix that was prepared in advance as initial state. For example, a dither matrix may be generated by: preparing a dither matrix that stores a plurality of threshold values in respective elements as initial state, where each of the threshold values is used for determination of dot on/off state of each pixel according to an input tone value; adjusting the dither matrix as initial state by replacing a part of the plurality of threshold values stored in the respective elements with different threshold value(s) stored in other element(s) by using a method determined in a random or organized way; and determining whether or not to make the replacement based on evaluation values respectively associated with the time before and after the replacement.

D-5: Although in above embodiments, dot on/off state of pixels are determined through comparison on a pixel-by-pixel basis of threshold values established in the dither matrix to the tone values of image data; however, it would also be acceptable to determine the dot on/off state by comparing the sum of threshold value and tone value to a fixed value, for example. It would also be acceptable to determine dot on/off state according to tone values, and data created previously on the basis of threshold values, rather than using threshold values directly. Generally speaking, the halftone process of the present invention may be any process that permits dot on/off state to be determined according to tone values of pixels, and threshold values established at corresponding pixel locations in a dither matrix.

D-6: Although in above embodiments, threshold values are read out of a dither matrix in order to determine dot on/off state; however, the present invention would also be applicable to such techniques disclosed in JP-A-2005-236768 and JP-A-2005-269527 that employ intermediate data (number data) for specifying state of dot formation.

D-7: Although in above embodiments, it is assumed that three sizes of dots, i.e. large-size dot, medium-size dot, and small-size dot can be formed; however the present invention would also be applicable to other cases such as two types of dots can be formed or four or more types of dots can be formed. Furthermore, although a halftone process is performed by employing a dither method with respect to large-size dot and medium-size dot and by employing an error diffusion method with respect to small-size dot among the three sizes of dots i.e. large-size dot, medium-size dot, and small-size dot in the present embodiment, it would also be acceptable to perform a halftone process by employing a dither method with respect to large-size dot and by employing an error diffusion method with respect to medium-size dot and small-size dot. In case where a halftone process is performed by employing an error diffusion method with respect to medium-size dot and small-size dot, it would also be acceptable to employ an error diffusion that uses two threshold values to realize ternarization.

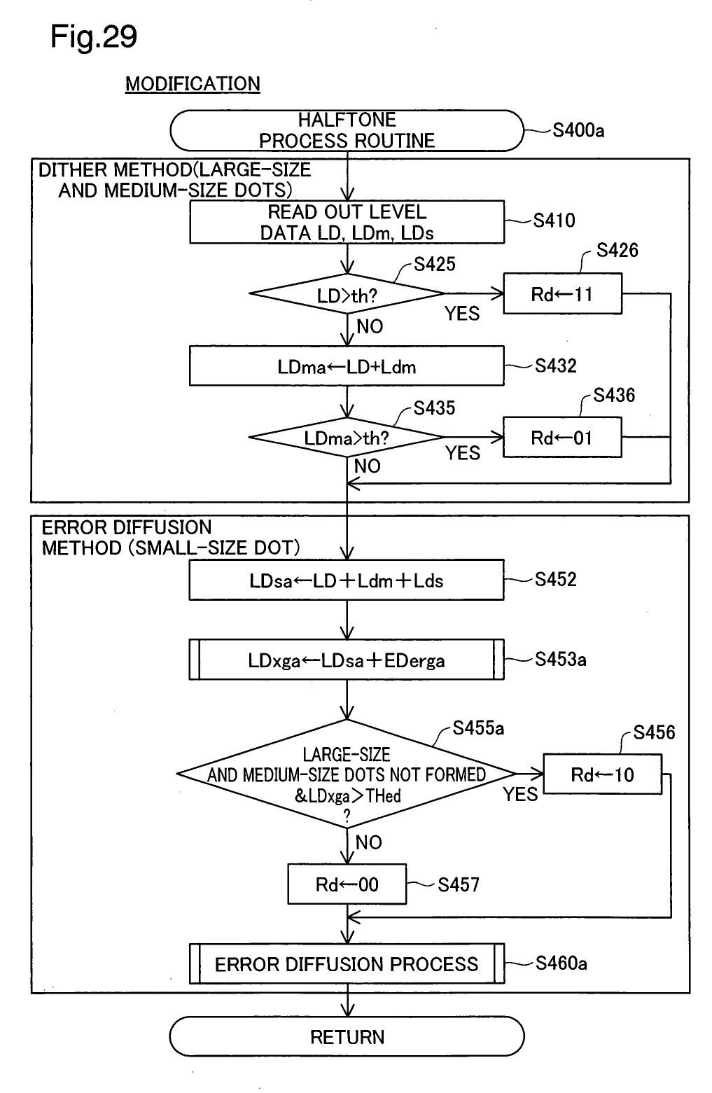

D-8: In the error diffusion method of above embodiments, no consideration is given to degradation of image quality caused by performing a plural times of scans to form ink dots in a common region on a printing medium to print an image. However, in order to reduce such degradation of image quality, it would also be acceptable to configure the error diffusion method such that every one of a plurality of dot groups has a predetermined characteristic (good dot dispersion). Such error diffusion method (FIG. 29) was created by the inventors of the present application for the first time, and can be realized by replacing steps of S453 (correction data generation process), S455 (dot on/off state determination process), and S460 (error diffusion process) of the error diffusion method shown in FIG. 9 with steps of S453a, S455a, and S460a, respectively.

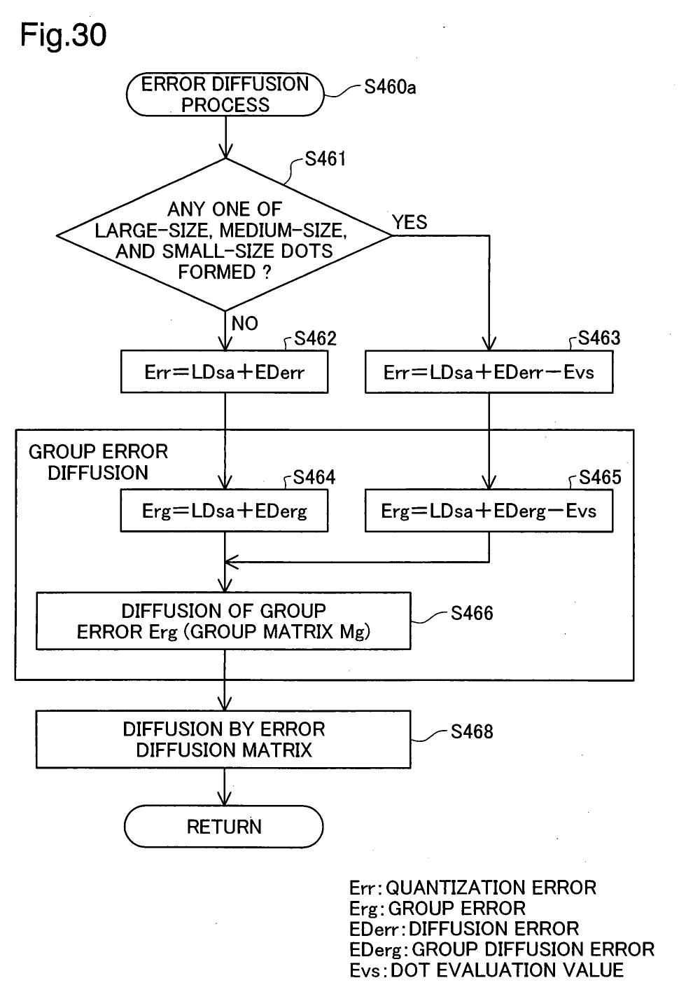

FIG. 30 is a flowchart showing the error diffusion process (step S460a) in the modification of the present invention. The error diffusion process is different from the error diffusion process of the embodiment (FIG. 12) in that a group error diffusion process (the process inside the frame) i.e. a process for providing a predetermined characteristic to every one of a plurality of dot groups is added. The group error diffusion process includes three steps (from S464 to S466).

In step S464, the halftone module 99 generates a group error Erg in a similar way to step S462 (FIG. 12), by adding correction level data for small-size dot LDsa to a group diffusion error EDerg. The method of generating group diffusion error EDerg will be described later.

In step S465, the halftone module 99 calculates a group error Erg in a similar way to step S463 (FIG. 12), by subtracting an dot evaluation value Evs from a sum of the correction level data for small-size dot LDsa and the group diffusion error EDerg.

In step S466, the halftone module 99 diffuses the group error Erg to neighboring pixels that are not processed yet and belong to the same pixel group, and thereby generates a group diffusion error EDerg. Such diffusion of error is realized by performing a process similar to that of the diffusion error EDerr, by using an error diffusion same-main scan group matrix Mg1 instead of the error diffusion entire matrix Ma.

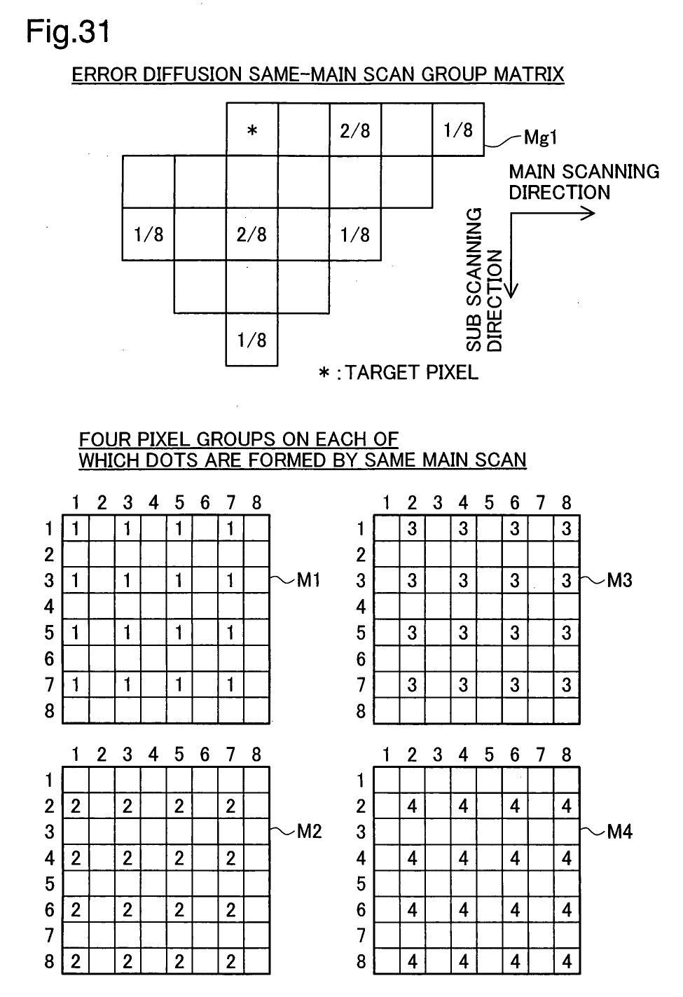

FIG. 31 an illustration depicting an error diffusion same-main scan group matrix Mg1 that is used for the purpose of performing additional error diffusion into the same pixel group as the target pixel. The error diffusion same-main scan group matrix Mg1 is an error diffusion matrix used for the purpose of performing additional error diffusion into the same pixel group as the target pixel among the first to fourth pixel groups on each of which dots are formed by each main scan. Four divided matrices M1-M4 are shown for the purpose of representing positional relationships of the first to fourth pixel groups and are the same as the matrices used in the process of dither optimization (FIG. 21).

For example, in case where the target pixel belongs to the first pixel group, the error will be diffused to pixels that correspond to elements storing “1” in the divided matrix M1. The error diffusion same-main scan group matrix Mg1 is configured as an error diffusion matrix that stores coefficients for error-diffusion-use for performing error diffusion into these pixels. It is found that the same error diffusion matrix is also applicable to cases where the target pixel belongs to either one of the second to fourth pixel groups on each of which dots are formed by the same main scan (pass), since the target pixel and other pixels have the same relative positional relationship as in the first pixel group.

As described above, in the present embodiment, the error diffusion is performed in such a way that the error diffusion using the error diffusion entire matrix Ma provides a predetermined characteristic to the final dot pattern and the error diffusion using the error diffusion same-main scan group matrix Mg1 provides the predetermined characteristic to each of dot patterns corresponding to the plurality of pixel groups.

The group diffusion error EDerg and the diffusion error EDerr thus generated are used in step S453a (FIG. 29) to generate correction data LDxga, which is used for determination of dot on/off state in the modification (step S455a in FIG. 29).

In step S453a (FIG. 29), the halftone module 99 generates correction data LDxga. The correction data LDxga is calculated as a sum of correction level data for small-size dot LDsa and a weighted average error EDerga. The weighted average error EDerga is calculated as a weighted average of a group diffusion error EDerg and a diffusion error EDerr. In the present modification, weights of “4” and “1” are respectively used for the diffusion error EDerr and the group diffusion error EDerg, as an example. The weighted average error EDerga is calculated as a value that is obtained by adding a product of the diffusion error EDerr and the weight of “4” and a product of the group diffusion error EDerg and the weight of “1” and then dividing the sum by a total sum of the weights “5”.

As described above, in the present modification, since the error diffusion process for all pixels and the error diffusion process only for pixels belonging to the same pixel group are performed independently from each other, it is possible to improve both dispersion of dots formed on all pixels and dispersion of dots formed only on pixels belonging to the same pixel group. In this way, it is possible to reduce degradation of image quality caused by performing a plural times of scans to form ink dots in a common region on a printing medium to print an image.

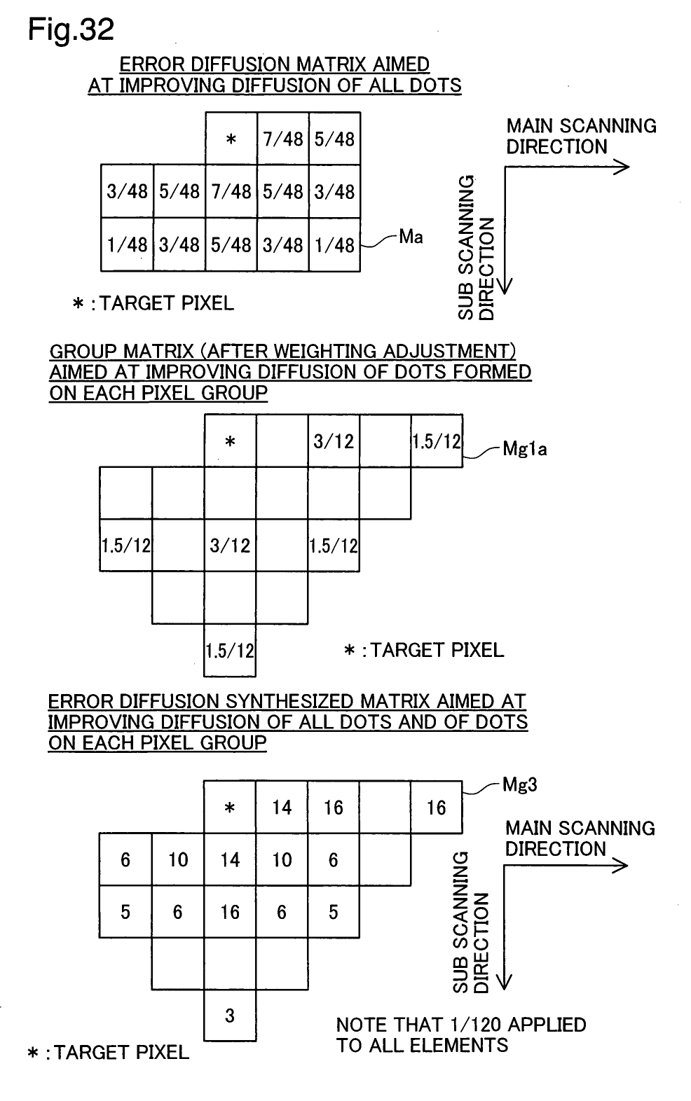

However, considering that both the error diffusion process targeted at all pixels and the error diffusion process targeted at each pixel group result in zero error in global scale, it would also be possible to process both of the error diffusions by using a single error diffusion buffer (not shown). Specifically, it can easily be attained by performing an error diffusion process using an error diffusion synthesized matrix Mg3 as shown in FIG. 32 instead of the error diffusion matrix Ma (FIG. 12) in the process of the embodiment (FIG. 9).

The error diffusion synthesized matrix Mg3 is generated by synthesizing the error diffusion matrix Ma (FIG. 12) aimed at improving dispersion of all dots and a group matrix Mg1a aimed at improving dispersion of dots formed on each pixel group. The group matrix Mg1a is a matrix obtained by subjecting the error diffusion same-main scan group matrix Mg1 (FIG. 31) to the weighting process described above.

Finally, the Japanese patent application (JP-A-2006-272215 filed on Oct. 3, 2006) on which the priority claim of the present application is based is incorporated herein by reference.

What is claimed is:

1. A printing method of printing on a printing medium, comprising:
generating dot data that represents state of dot formation at each print pixel of a print image to be formed on the printing medium by performing a halftone process on image data that represents an input tone value of each pixel making up an original image;
providing a print head capable of selectively forming N types of dots having mutually different sizes on a region of one pixel on the printing medium, N being an integer of at least 2; and
generating the print image according to the dot data by mutually combining a plurality of dot groups in a common print region, each of the plurality of dot groups being formed on each of a plurality of pixel groups that assume mutually physical differences in a process of dot formation, wherein
the generating dot data includes:
executing the halftone process by using an error diffusion method with respect to smaller-size-side dot among the N types of dots; and
executing the halftone process by using a dither method with respect to larger-size-side dot among the N types of dots, a condition of halftone process of the dither method being set such that all of the dot groups have a first predetermined characteristic.

2. The printing method according to claim 1, wherein
the error diffusion method performs error diffusion according to state of dot formation of the larger-size-side dot and state of dot formation of the smaller-size-side dot.

3. The printing method according to claim 2, wherein
the error diffusion method performs error diffusion according to the state of dot formation of the larger-size-side dot, under an assumption that the smaller-size-side dot is formed when the larger-size-side dot is formed.

4. The printing method according to claim 1, wherein
the first predetermined characteristic is either one of blue noise characteristics and green noise characteristics.

5. The printing method according to claim 1, wherein
the error diffusion method is set such that all of the dot groups have a second characteristic with respect to the smaller-size-side dot.

6. The printing method according to claim 1, wherein
each of the dot groups has a frequency characteristic such that an average value of components within a specified low frequency range ranging from 0.5 cycles per millimeter to 2 cycles per millimeter with a central frequency of 1 cycle per millimeter is smaller than an average value of components within another frequency range ranging from 5 cycles per millimeter to 20 cycles per millimeter with a central frequency of 10 cycles per millimeter, on a printing medium with respect to the larger-size-side dot.

7. The printing method according to claim 1, wherein
the generating the print image includes forming three types of dots on a region of one pixel, the three types of dots including large-size dot having a largest size, small-size dot having a smallest size, and medium-size dot having a size that is smaller than the large-size dot and larger than the small-size dot, and
the generating dot data includes executing the halftone process by using an error diffusion method with respect to the small-size dot as the smaller-size-side dot, and by using the dither method with respect to the large-size dot and the medium-size dot as the larger-size-side dot.

8. The printing method according to claim 1, wherein
the generating the print image includes forming three types of dots on a region of one pixel, the three types of dots including large-size dot having a largest size, small-size dot having a smallest size, and medium-size dot having a size that is smaller than the large-size dot and larger than the small-size dot, and
the generating includes a step of executing the halftone process by using an error diffusion method with respect to the small-size dot and the medium-size dot as the smaller-size-side dot, and by using the dither method with respect to the large-size dot as the larger-size-side dot.

9. A printing apparatus for printing on a printing medium, comprising:
a dot data generator that generates dot data that represents state of dot formation at each print pixel of a print image to be formed on the printing medium by performing a halftone process on image data that represents an input tone value of each pixel making up an original image; and
a print image generator that has a print head capable of selectively forming N types of dots having mutually different sizes on a region of one pixel on the printing medium, N being an integer of at least 2, and forms the print image according to the dot data by mutually combining a plurality of dot groups in a common print region, each of the plurality of dot groups being formed on each of a plurality of pixel groups that assume mutually physical differences in a process of dot formation, wherein
the dot data generator executes the halftone process by using an error diffusion method with respect to smaller-size-side dot among the N types of dots, and executes the halftone process by using a dither method with respect to larger-size-side dot among the N types of dots, a condition of halftone process of the dither method being set such that all of the dot groups have a first predetermined characteristic.

10. A computer program product for causing a computer to generate print data to be supplied to a print image generator, the computer program product comprising:
a computer readable medium; and
a computer program stored on the computer readable medium, the computer program comprising a program for causing the computer to generate dot data that represents state of dot formation at each print pixel of a print image to be formed on the printing medium by performing a halftone process on image data that represents an input tone value of each pixel making up an original image, wherein
the print image generator has a print image generator that has a print head capable of selectively forming N types of dots having mutually different sizes on a region of one pixel on the printing medium, N being an integer of at least 2, and forms the print image according to the dot data by mutually combining a plurality of dot groups in a common print region, each of the plurality of dot groups being formed on each of a plurality of pixel groups that assume mutually physical differences in a process of dot formation, wherein
the program includes:
a program for causing the computer to execute the halftone process by using an error diffusion method with respect to smaller-size-side dot among the N types of dots; and
a program for causing the computer to execute the halftone process by using a dither method with respect to larger-size-side dot among the N types of dots, a condition of halftone process of the dither method being set such that all of the dot groups have a first predetermined characteristic.
